(19) United States
(12) Patent Application Publication
(10) Pub. No.: US 2026/0193834 A1
(43) Pub. Date: Jul. 9, 2026

(54) GRAFT POLYMERIZATION OF CATIONIC MONOMERS INTO CELLULOSIC FIBERS FOR SIMULTANEOUS SUSTAINABLE DYEING AND FINISHING

(71) Applicant: NORTH CAROLINA STATE UNIVERSITY, Raleigh, NC (US)

(72) Inventors: Ahmed M. EL-SHAFEI, Cary, NC (US); Shahriar SALIM, Lexington, SC (US)

(21) Appl. No.: 19/131,832

(22) PCT Filed: Nov. 21, 2023
(86) PCT No.: PCT/IB2023/061758

§ 371 Date: May 21, 2025

Related U.S. Application Data
(60) Provisional application No. 63/427,337, filed on Nov. 22, 2022.

(51) Int. Cl. D06M 14/04; D06M 16/00; D06M 101/06; D06P 3/60; D06P 3/62; D06P 3/66; D06P 5/00

(52) U.S. Cl. CPC D06M 14/04; D06M 16/00; D06P 3/60; D06P 3/6008; D06P 3/62; D06P 3/66; D06P 5/002; D06M 2101/06

(57) ABSTRACT

Disclosed herein are methods for graft polymerizing cationic alkenyl monomers, or polymers made therefrom, into undyed or dyed cellulosic materials. Further provided are methods for dyeing such cationized cellulosic materials, and to dyed or undyed cationized cellulosic materials prepared by the disclosed methods.

### TECHNICAL FIELD

The disclosure relates to methods of free-radical graft polymerizing cationic monomers into undyed or dyed cellulosic fibers (e.g., cotton, such as knit, velvet, terry cloth, and woven cotton fabric) to provide a cationized fiber. The disclosure is further related to methods of dyeing cationized cellulosic fibers in the absence of salts and to the resulting dyed cationized cellulosic fibers. Dyeing of such cationized cellulosic fibers can be achieved via exhaustion, pad-steam, cold-pad batch, or foam dyeing at room or higher temperature using a reactive dye, a direct dye, a natural dye, or an acid dye.

### BACKGROUND

Cellulosic fibers (e.g., cotton, rayon, viscose, linen, modal and lyocell) are major natural and semi-synthetic fibers and raw materials in textile manufacturing owing to their excellent physical and chemical characteristics such as natural comfort, feel, appearance, ease of production, hydrophilicity, good dyeability, color retention, breathability, moisture absorbency, no static electricity, biodegradability and low cost. See References 1-5. Cellulosic fibers or fabrics (e.g., cotton) can be dyed with reactive dyes to obtain a wide range of vibrant colors with excellent colorfastness properties, but reactive dyeing can result in significant water pollution. Despite being anionic, reactive dyes have moderate affinity for cellulosic fibers such as cotton and can form covalent bonds with the fibers in the presence of alkali. However, in order to provide sufficient dye exhaustion, large amounts of electrolyte (i.e., salts, such as Glauber's salt) are typically required to overcome the zeta potential between the anionic reactive dye and the native negatively charged cellulosic fiber surface when submerged in water. See References 3 and 5-11. Soda ash is generally used as the alkali to convert the primary hydroxyl groups (—CH₂OH) in the glucose residues of cellobiose (the repeat unit of cellulose), into negatively charged groups (CH₂O⁻) to allow for the nucleophilic attack of the CH₂O— group at one or more of the reactive sites in the reactive group(s) of the dye, resulting in the formation of covalent bonds between the fibers and reactive dyes. However, alkali also hydrolyzes a significant amount of the reactive dyes to an inactive form which cannot react with cellulosic fibers. See References 3, 7, 10, and 11. Thus, the effluent from a dye house can contain large amounts of salt, hydrolyzed dyes and other auxiliaries which can be hard to separate. This highly colored saline effluent can impair the biological ecosystem of fresh water and makes land barren by increasing salinity and alkalinity. See References 5-8 and 12-16. Therefore, there is an ongoing need for improved salt- and alkali-free reactive dyeing methods.

To reduce the salinity and alkalinity of effluent, newer dyeing machines have been introduced which run at an ultra-low liquor ratio (e.g., 4:1), thereby substantially lowering salt and alkali content of effluent. Another approach to reducing environmental pollution is to cationize cellulosic fibers prior to dyeing, as cationized cellulosic fibers can have higher affinity for reactive anionic dyes. See References 6, 7, and 17. Since 1926, researchers have investigated two types of cationizing agents for cotton based on their molecular weight. See References 18 and 19. Lewis and Lei examined several secondary amino, tertiary amino, quaternary amino, thiol and disulfide compounds for cotton cationization and reactive dye application. See Reference 21. For instance, 3-chloro-2-hydroxypropyltrimethylammonium chloride (CHPTAC) is a quaternary amine widely used for cationization of cotton. Scheme 1 illustrates the cationization of cellulosic fibers using CHPTAC. As shown in Scheme 1, in the presence of sodium hydroxide (NaOH), CHPTAC forms 2,3-epoxypropyltrimethylammonium chloride (EPTAC), which subsequently reacts covalently with the negatively charged hydroxyl groups (CH₂O—) in the glucose units comprising cotton's cellulosic polymer, providing cationized cotton with trimethylamine (TMA) as a byproduct.

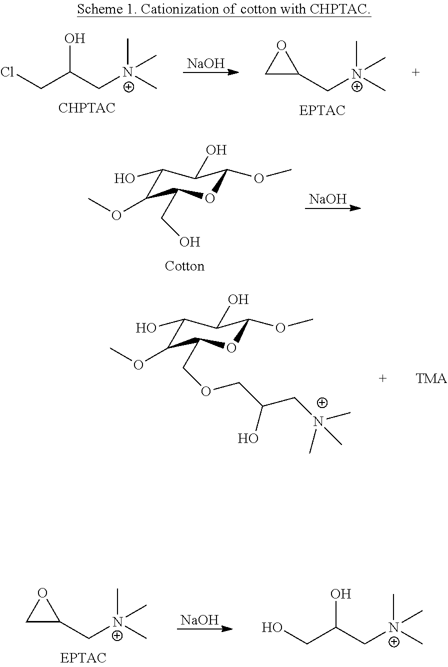

Cationization of cotton with CHPTAC and the dyeing of the CHPTAC-cationized cotton with reactive dyes in the absence of salt has been reported to achieve higher dye exhaustion, good dyeing levelness, better color yield, and similar colorfastness properties compared to untreated cotton dyed using the traditional method. See References 2, 3, 5, 6, 9, 13, 14, 17, and 20-25. However, there are disadvantages of cationizing cellulosic fibers with CHPTAC. For instance, EPTAC is carcinogenic and poses serious occupational hazards. Secondly, as illustrated in Scheme 1, the NaOH present during cationization hydrolyzes 40-60% of EPTAC to an inactive diol. Therefore, a large amount of CHPTAC is required to compensate the loss due to hydrolysis. Thirdly, the TMA byproduct has the odor of dead fish. Finally, cotton cationized with CHPTC is highly basic and typically requires washing and neutralization with acid (e.g., citric acid) prior to dye application. See References 2, 3, 5, 6, 9, 13, 14, 17, and 20-27.

Low substantivity, toxicity, foul odor and poor thermal stability are observed with cationic agents such as EPTAC. To overcome these issues, researchers have shifted their focus towards natural and synthetic polymeric cationic agents. See References 18 and 19. For example, Wu and Chen cationized cotton with polyepichlorohydrin-dimethylamine and dyed with reactive dyes to obtain higher color yield and better wash fastness properties. See Reference 28. Blackburn and Burkinshaw used polymers of 4-vinylpyridine quaternized with 1-amino-2-chloroethane and a copolymer of diallyldimethyl ammonium chloride and 3-aminoprop-1-ene for cotton cationization. They then dyed the cationized cotton with reactive dyes to obtain uniform levelness, higher color yield and better wash fastness properties. See Reference 29. Ma et al. cationized cotton with poly(vinylamine chloride) and dyed with reactive dyes to obtain uniform levelness, higher dye fixation and better wash fastness properties. See Reference 30. Dehabadi et al. cationized cotton using polyamino carboxylic acids and dyed with reactive dyes to obtain higher color yield and comparable rub fastness and wash fastness properties. See Reference 31. Zhang et al. cationized cotton with an amino-terminated hyperbranched polymer and dyed with reactive dyes to obtain higher color yield and comparable rub fastness and wash fastness properties. See References 32-34. Burkinshaw et al. cationized cotton using dendrimers and dyed with reactive dyes to obtain higher color yield than untreated cotton dyed using a traditional method. See Reference 35. Lim and Hudson cationized cotton with a novel water-soluble chitosan derivative (O-acrylamidomethyl-N-[(2-hydroxy-3-trimethylammonium)propyl]chitosan chloride) and dyed with reactive dyes to obtain higher color yield and better wash fastness properties. See Reference 36. Sadeghi-Kiakhani and Safapour cationized cotton using chitosan-poly(propylene imine) dendrimer hybrid and dyed with reactive dyes to obtain higher color yield and comparable colorfastness properties. See Reference 37. Ali et al. cationized cotton with cationic starch and dyed with reactive dyes to obtain higher color yield and comparable colorfastness properties. See Reference 38.

Despite these successful alternative cotton cationizations and dyeing, cotton cationized with polymeric agents can exhibit ring dyeing and poor lightfastness properties due to the abundance of cationic sites on the fiber surface rather than within the fiber. See References 18 and 19. Accordingly, there is an ongoing need for additional methods of cationizing cellulosic fibers, particularly cationizing cotton and/or dyeing cationized cotton.

### SUMMARY

Provided herein are methods of cationizing cellulosic fibers by graft polymerization and methods of dyeing such cationized cellulosic fibers. The methods are applicable to any cellulosic fibers, including but not limited to cotton, cotton-polyester blends, cotton-nylon blends, rayon, viscose, linen, modal, tencel and monocel. The cellulosic fibers may be in the form of actual fibers, or as fabrics, yarns, wovens, nonwovens, knits, terry cloths, velvets, and the like. In certain embodiments, the method disclosed herein is advantageous in reducing occupational hazards associated with toxic cationizing reagents, avoiding the production of foul-odored byproducts, avoiding the need for neutralization, requiring less washing, reducing effluent, and reducing cost and increasing speed, as compared to cationization processes utilizing CHPTAC. Further, the cationized cellulosic fibers produced by the disclosed method may, in some embodiments, be dyed without use of salts (e.g., sodium sulfate and/or alkalis such as sodium carbonate) and without loss of favorable properties with respect to dyeing (e.g., color yield, colorfastness), and the dye bath is clear and recyclable.

The methods generally comprise cationizing cellulosic fibers by graft polymerization with a cationic alkenyl monomer in the presence of a thermal initiator and a crosslinker, thereby providing a cationized cellulosic fiber or fabric. The cationized cellulosic fiber or fabric comprises cellulose polymers comprising polysaccharide chains comprising a plurality of glucose residues having hydroxymethyl groups and have cationic polymeric side chains covalently bonded to at least a portion of the hydroxymethyl groups present in the plurality of glucose residues.

Accordingly, in one aspect is provided a method of cationizing a cellulosic fiber or fabric by graft polymerization, the cellulosic fiber or fabric comprising polysaccharide chains comprising a plurality of glucose residues having hydroxymethyl groups, the method comprising:
contacting the cellulosic fiber or fabric with a solution comprising a cationic alkenyl monomer, a thermal initiator, and a crosslinker to form an impregnated cellulosic fiber or fabric; and
curing the impregnated cellulosic fiber or fabric to form a cationized cellulosic fiber or fabric,
   wherein the cationized cellulosic fiber or fabric comprises cationic polymeric side chains covalently bonded to at least a portion of the hydroxymethyl groups present in the plurality of glucose residues.

In some embodiments, the cationic alkenyl monomer comprises one or more vinyl groups.

In some embodiments, the cationic alkenyl monomer comprises one or more allyl groups, such as one, two, three, or four allyl groups.

In some embodiments, the cationic alkenyl monomer comprises an acrylate, methacrylate, acrylamide, or methacrylamide group.

In some embodiments, the cationic alkenyl monomer is selected from the group consisting of diallyldimethyl ammonium chloride (DADMAC), 2-(acryloyloxy)ethyl trimethylammonium chloride (AOETMAC), 2-(methacryloyloxy)ethyl trimethylammonium chloride (MOETMAC), (3-acrylamidopropyl)trimethylammonium chloride (AAPTMAC), [3-(methylacryloylaminopropyl]trimethylammonium chloride (MAPTMAC), tetraallyl ammonium bromide (TAAB), tetraallyl ammonium chloride (TAAC), N,N,N′,N′-tetraallyl trimethylene dipiperidine dibromide (TAMPB), N,N,N′,N′-tetraallyl trimethylene dipiperidine dichloride (TAMPC), and combinations thereof.

In some embodiments, the cationic alkenyl monomer is DADMAC.

In some embodiments, the thermal initiator is selected from the group consisting of sodium potassium persulfate, potassium persulfate, ammonium persulfate, ceric ammonium nitrate, azobisisobutyronitrile, 2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]-dihydrochloride, 4,4′-Azobis(4-cyanovaleric acid), or 2,2′-Azobis[N-(2-carboxyethyl)-2-methylpropionamidine]-tetrahydrate, organic peroxides, organic hydroperoxides, and combinations thereof.

In some embodiments, the thermal initiator is sodium persulfate or potassium persulfate.

In some embodiments, the crosslinker is selected from the group consisting of N,N′-methylenebisacrylamide (MBA), pentaerythritol triacrylate, N-[Tris(3-acrylamidopropoxymethyl)methyl]-acrylamide, a polyethylene glycol diacrylate or derivative thereof, tetra(ethylene glycol) diacrylate, pentaerythritol tetraacrylate, and combinations thereof.

In some embodiments, the crosslinker is selected from the group consisting of MBA, pentaerythritol tetraacrylate, tetra(ethylene glycol) diacrylate, and polyethylene glycol diacrylates.

In some embodiments, the crosslinker is MBA.

In some embodiments, the crosslinker is pentaerythritol tetraacrylate.

In some embodiments, the crosslinker is tetra(ethylene glycol) diacrylate.

In some embodiments, the crosslinker is a polyethylene glycol diacrylate.

In some embodiments, the cationic alkenyl monomer, thermal initiator, and crosslinker are present together in a solution.

In some embodiments, contacting comprises dipping the cellulosic fiber or fabric into the solution.

In some embodiments, contacting comprises passing the cellulosic fiber or fabric through the solution in a continuous manner.

In some embodiments, the method further comprises mechanically removing a portion of the solution from the impregnated fibers or fabric.

In some embodiments, the contacting is repeated sequentially one or more times.

In some embodiments, contacting the cellulosic fiber or fabric with the cationic alkenyl monomer, thermal initiator, and crosslinker is conducted at a temperature in a range from about 0° C. to about 40° C., and/or for a time period in a range from a few seconds to about 5 minutes.

In some embodiments, the method further comprises, prior to the curing, drying the impregnated cellulosic fiber or fabric.

In some embodiments, the drying is conducted for a time period from about 2 minutes to about 8 minutes.

In some embodiments, the drying is conducted at a temperature in a range from about 80° C. to about 130° C.

In some embodiments, curing comprises exposing the impregnated cellulosic fiber or fabric to a temperature in a range from about 130° C. to about 180° C., optionally for a time period from about 1 minute to about 3 minutes.

In some embodiments, the drying and curing are conducted simultaneously at a temperature in a range from about 80° C. to about 180° C. for a period of time in a range from about 0.5 to about 8 minutes.

In some embodiments, method of any one of claims 1-19, further comprising washing the cationized cellulosic fiber or fabric.

In some embodiments, the cellulosic fiber or fabric is cotton, a cotton blend, rayon, viscose, linen, modal, lyocell, or a combination thereof.

In some embodiments, the cellulosic fiber or fabric is in the form of a thread, yam, knit, woven, terry, or velvet.

In another aspect is provided a method of cationizing a cellulosic fiber or fabric by graft polymerization, the cellulosic fiber or fabric comprising polysaccharide chains comprising a plurality of glucose residues having hydroxymethyl groups, the method comprising:
contacting the cellulosic fiber or fabric with a solution comprising a cationic polymer to form an impregnated cellulosic fiber or fabric;
contacting the impregnated cellulosic fiber or fabric with a solution comprising a thermal initiator; and
curing the impregnated cellulosic fiber or fabric to form a cationized cellulosic fiber or fabric, wherein the cationized cellulosic fiber or fabric comprises cationic polymeric side chains covalently bonded to at least a portion of the hydroxymethyl groups present in the plurality of glucose residues.

In some embodiments, the cationic polymer is a cationic polyacrylate, a cationic polymethacrylate, a cationic polyacrylamide, a cationic polymethacrylamide, or a combination thereof.

In some embodiments, the cationic polymer is poly-diallyldimethyl ammonium chloride (poly-DADMAC).

In some embodiments, the molecular weight range of the cationic polymer is from about 50,000 to about 750,000 daltons, or from about 100,000 to about 500,000 daltons.

In some embodiments, the thermal initiator is selected from the group consisting of sodium potassium persulfate, potassium persulfate, ammonium persulfate, ceric ammonium nitrate, azobisisobutyronitrile, 2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]dihydrochloride, 4,4′-Azobis(4-cyanovaleric acid), or 2,2′-Azobis[N-(2-carboxyethyl)-2-methylpropionamidine]tetrahydrate, organic peroxides, organic hydroperoxides, and combinations thereof.

In some embodiments, the thermal initiator is sodium persulfate or potassium persulfate.

In some embodiments, contacting the cellulosic fiber or fabric with the cationic polymer comprises dipping the cellulosic fiber or fabric into the solution comprising the cationic polymer.

In some embodiments, contacting the cellulosic fiber or fabric with the cationic polymer comprises passing the cellulosic fiber or fabric through the solution comprising the cationic polymer in a continuous manner.

In some embodiments, the method further comprises mechanically removing a portion of the cationic polymer solution from the impregnated fibers or fabric.

In some embodiments, the contacting is repeated sequentially one or more times.

In some embodiments, contacting the cellulosic fiber or fabric with the solution comprising the cationic alkenyl monomer is conducted at a temperature in a range from about 10° C. to about 50° C., and/or for a time period in a range from a few seconds to about 5 minutes.

In some embodiments, the method further comprises, prior to contacting the cellulosic fiber or fabric with the solution comprising the thermal initiator, drying the impregnated cellulosic fiber or fabric.

In some embodiments, the drying is conducted for a time period from about 2 minutes to about 8 minutes.

In some embodiments, the drying is conducted at a temperature in a range from about 80° C. to about 130° C.

In some embodiments, contacting the cellulosic fiber or fabric with the solution comprising the thermal initiator comprises dipping the cellulosic fiber or fabric into the solution comprising the cationic polymer or passing the cellulosic fiber or fabric through the solution comprising the cationic polymer in a continuous manner.

In some embodiments, the method further comprises mechanically removing a portion of the solution comprising the thermal initiator from the impregnated fibers or fabric.

In some embodiments, the method further comprises, prior to the curing, drying the impregnated cellulosic fiber or fabric.

In some embodiments, the drying is conducted for a time period from about 2 minutes to about 8 minutes.

In some embodiments, the drying is conducted at a temperature in a range from about 80° C. to about 130° C.

In some embodiments, curing comprises exposing the impregnated cellulosic fiber or fabric to a temperature in a range from about 130° C. to about 180° C., optionally for a time period from about 1 minute to about 3 minutes.

In some embodiments, the method further comprises washing the cationized cellulosic fiber or fabric.

In some embodiments, the cellulosic fiber or fabric is cotton, a cotton blend, rayon, viscose, linen, modal, lyocell, or a combination thereof.

In some embodiments, the cellulosic fiber or fabric is in the form of a thread, yam, knit, woven, terry, or velvet.

In a further aspect is provided a cationized cellulosic fiber or fabric prepared by the method disclosed herein.

In a still further aspect is provided a cationized cellulosic fiber or fabric comprising polysaccharide chains comprising a plurality of glucose residues having hydroxymethyl groups and cationic polymeric side chains covalently bonded to at least a portion of the hydroxymethyl groups present in the plurality of glucose residues, the cationic polymeric side chains comprising a polyacrylate, a polymethacrylate, a polyacrylamide, a polymethacrylamide, a poly-diallyldimethylammonium polymer, or a combination thereof.

In some embodiments, the cationized cellulosic fiber or fabric comprises a crosslinked polydiallyldimethylammonium polymer, said cationized cellulosic fiber or fabric comprising a structure according to Formula I:

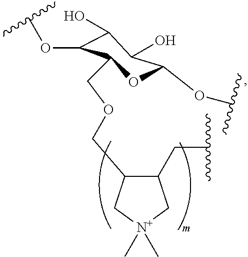

wherein m is in a range from about 200 to about 500.

In some embodiments, the cationized cellulosic fiber or fabric has a weight average molecular weight of the cationic polymeric side chain is from about 10,000 to about 60,000.

In some embodiments, the cationized cellulosic fiber or fabric comprises a polyacrylate or a polymethacrylate polymer, said cationized cellulosic fiber or fabric comprising a structure according to one of the following formulae:

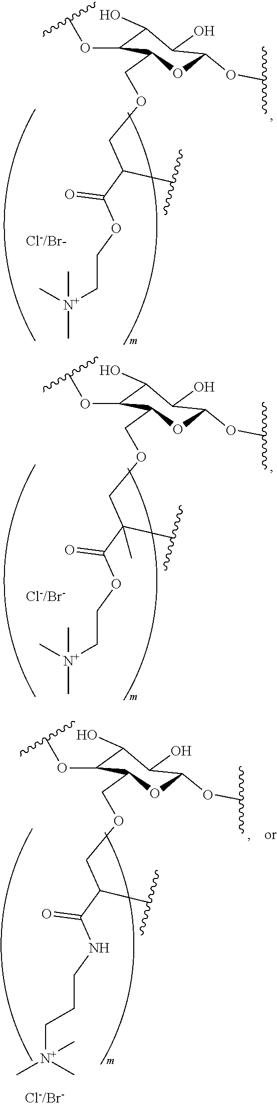

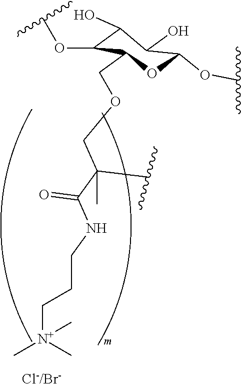

wherein m is in a range from about 200 to about 500.

In some embodiments, the cationized cellulosic fiber or fabric comprises a poly-tetraallyldimethylammonium polymer, said cationized cellulosic fiber or fabric comprising a structure according to one of the following formulae:

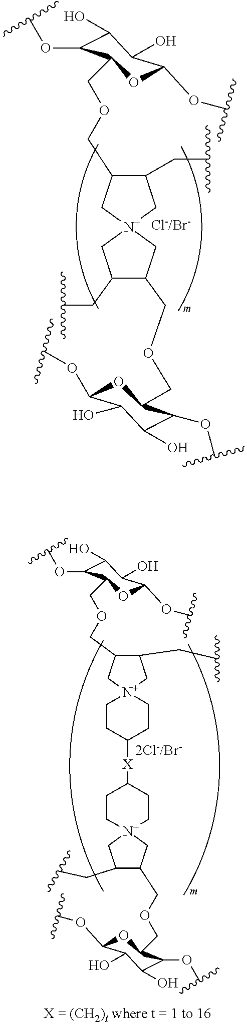

wherein m is in a range from about 200 to about 500.

In a yet further aspect is provided a dyed cellulosic fiber or fabric comprising the cationized cellulosic fiber or fabric as disclosed herein, and further comprising a dye ionically bound thereto.

In some embodiments, the dyed cellulosic fiber or fabric has antimicrobial properties.

In some embodiments, the dyed cellulosic fiber or fabric provides a reduction of about 99.99% or more of Gram-positive bacteria compared to an undyed, non-cationized cellulosic fiber or fabric control after 24 hours.

In some embodiments, the dyed cellulosic fiber or fabric provides a reduction of about 99% or more of Gram-negative bacteria compared to an undyed, non-cationized cellulosic fiber or fabric control after 24 hours.

In a still further aspect is provided a method of dyeing a cationized cellulosic fiber or fabric, the cationized cellulosic fiber or fabric comprising polysaccharide chains comprising a plurality of glucose residues having hydroxymethyl groups and cationic polymeric side chains covalently bonded to at least a portion of the hydroxymethyl groups present in the plurality of glucose residues, the cationic polymeric side chains comprising a polyacrylate, a polyacrylamide, a polymethacrylate, a polymethacrylamide, a poly-diallyldimethylammonium, a poly-tetraallylammonium polymer, or a combination thereof, the method comprising contacting the cationized cellulosic fiber or fabric with a solution comprising a dye.

In some embodiments, the solution is substantially free of alkaline salts.

In some embodiments, the solution is substantially free of neutral and acidic salts.

In some embodiments, the solution is substantially free of neutral, acidic, and alkaline salts.

In some embodiments, the solution has a pH in a range from about 6.8 to about 7.4.

In some embodiments, the dyeing is performed via exhaustion dyeing, a pad-steam-dry method, or foam dyeing method.

In some embodiments, dyeing comprises contacting the cationized cellulosic fiber or fabric with the solution comprising the dye in a foam dyeing machine.

In some embodiments, the dye solution after dyeing is clear and is a recyclable bath.

In some embodiments, when the water of the dye bath after dyeing was used to prepare another dye bath by adding the same amount of dye used in the fresh dye bath, the dyed cationized cellulosic fiber or fabric dyed using the recyclable bath had comparable color yield and/or colorfastness to a dyed cellulosic fiber or fabric prepared from the same cationized cellulosic fiber or fabric dyed in a corresponding fresh dye bath.

In some embodiments, dyeing comprises exhaustion dyeing, and wherein the dyed cellulosic fiber or fabric has a higher color yield and/or a comparable colorfastness as compared to a dyed cellulosic fiber or fabric prepared by exhaustion dyeing a cationized cellulosic fiber or fabric which has been cationized by treatment with 3-chloro-2-hydroxypropyltrimethylammonium chloride (CHPTAC).

In some embodiments, dyeing comprises contacting the cationized cellulosic fiber or fabric with dye using a pad-steam-dry method in the absence of salts, and wherein the dyed cellulosic fiber or fabric has a higher color yield compared to a non-cationized cellulosic fiber or fabric dyed using a pad-steam-dry method with salts, and/or as compared to a CHPTAC-treated cellulosic fiber or fabric dyed using a pad-steam-dry method in the absence of salts.

In some embodiments, dyeing comprises contacting the cationized cellulosic fiber or fabric with an acid dye or a direct dye, and wherein the dyed cellulosic fiber or fabric has comparable colorfastness to a dyed cellulosic fiber or fabric prepared by acid or a direct dyeing a cationized cellulosic fiber or fabric prepared by treatment with CHPTAC.

In another aspect is provided a dyed, cationized cellulosic fiber or fabric prepared by the method disclosed herein.

The disclosure includes, without limitations, the following embodiments.

Embodiment 1: A method of cationizing a cellulosic fiber or fabric by graft polymerization, the cellulosic fiber or fabric comprising polysaccharide chains comprising a plurality of glucose residues having hydroxymethyl groups, the method comprising: contacting the cellulosic fiber or fabric with a cationic alkenyl monomer, a thermal initiator, and a crosslinker to form an impregnated cellulosic fiber or fabric; and curing the impregnated cellulosic fiber or fabric to form a cationized cellulosic fiber or fabric, wherein the cationized cellulosic fiber or fabric comprises cationic polymeric side chains covalently bonded to at least a portion of the hydroxymethyl groups present in the plurality of glucose residues.

Embodiment 2: The method of Embodiment 1, wherein the cationic alkenyl monomer comprises one or more allyl groups.

Embodiment 3: The method of Embodiment 1, wherein the cationic alkenyl monomer comprises an acrylate, methacrylate, acrylamide, or methacrylamide group.

Embodiment 4: The method of any one of Embodiments 1-3, wherein the cationic alkenyl monomer is selected from the group consisting of diallyldimethyl ammonium chloride (DADMAC), 2-(acryloyloxy)ethyl trimethylammonium chloride (AOETMAC), 2-(methacryloyloxy)ethyl trimethylammonium chloride (MOETMAC), (3-acrylamidopropyl)trimethylammonium chloride (AAPTMAC), [3-(methylacryloylaminopropyl]trimethylammonium chloride (MAPTMAC), tetraallyl ammonium bromide (TAAB), tetraallyl ammonium chloride (TAAC), N,N,N′,N′-tetraallyl trimethylene dipiperidine dibromide (TAMPB), N,N,N′,N′-tetraallyl trimethylene dipiperidine dichloride (TAMPC), and combinations thereof.

Embodiment 5: The method of any one of Embodiments 1-4, wherein the cationic alkenyl monomer is DADMAC.

Embodiment 6: The method of any one of Embodiments 1-5, wherein the thermal initiator is selected from the group consisting of sodium potassium persulfate, potassium persulfate, ammonium persulfate, ceric ammonium nitrate, azobisisobutyronitrile, 2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]dihydrochloride, 4,4′-Azobis(4-cyanovaleric acid), or 2,2′-Azobis[N-(2-carboxyethyl)-2-methylpropionamidine]-tetrahydrate, organic peroxides, organic hydroperoxides, and combinations thereof.

Embodiment 7: The method of Embodiment 6, wherein the thermal initiator is sodium persulfate or potassium persulfate.

Embodiment 8: The method of any one of Embodiments 1-7, wherein the crosslinker is selected from the group consisting of N,N′-methylenebisacrylamide (MBA), pentaerythritol triacrylate, N-[Tris(3-acrylamidopropoxymethyl)methyl]-acrylamide, a polyethylene glycol diacrylate, tetra(ethylene glycol diacrylate), pentaerythritol tetraacrylate, and combinations thereof.

Embodiment 9: The method of Embodiment 8, wherein the crosslinker is selected from the group consisting of MBA, pentaerythritol tetraacrylate, a polyethylene glycol diacrylate, and tetra(ethylene glycol) diacrylate.

Embodiment 10: The method of any one of Embodiments 1-9, wherein contacting comprises dipping the cellulosic fiber or fabric into one or more solutions comprising one or more of the cationic alkenyl monomer, the thermal initiator, and the crosslinker.

Embodiment 11: The method of Embodiment 10, wherein the cationic alkenyl monomer, thermal initiator, and crosslinker are present together in a single solution contacted with the cellulosic fiber or fabric.

Embodiment 12: The method of Embodiment 10 or Embodiment 11, wherein contacting comprises passing the cellulosic fiber or fabric through the one or more solutions in a continuous manner.

Embodiment 13: The method of Embodiment 10 or Embodiment 11, further comprising mechanically removing a portion of the one or more solutions from the impregnated fibers or fabric.

Embodiment 14: The method of any one of Embodiments 10-13, wherein the contacting is repeated sequentially two or more times.

Embodiment 15: The method of any one of Embodiments 1-14, wherein contacting the cellulosic fiber or fabric with the cationic alkenyl monomer, thermal initiator, and crosslinker is conducted at a temperature in a range from about 10° C. to about 50° C., and/or for a time period in a range from a few seconds to about 5 minutes.

Embodiment 16: The method of any one of Embodiments 1-15, further comprising, prior to the curing, drying the impregnated cellulosic fiber or fabric.

Embodiment 17: The method of Embodiment 16, wherein the drying is conducted for a time period from about 2 minutes to about 8 minutes.

Embodiment 18: The method of Embodiment 16 or 17, wherein the drying is conducted at a temperature in a range from about 80° C. to about 130° C.

Embodiment 19: The method of any one of Embodiments 1-18, wherein curing comprises exposing the impregnated cellulosic fiber or fabric to a temperature in a range from about 110° C. to about 180° C., such as about 130° C. to about 180° C., optionally for a time period from about 1 minute to about 3 minutes.

Embodiment 20: The method of any one of Embodiments 1-19, further comprising washing the cationized cellulosic fiber or fabric.

Embodiment 21: The method of any one of Embodiments 1-20, wherein the cellulosic fiber or fabric is cotton, a cotton blend, rayon, viscose, linen, modal, lyocell, or a combination thereof.

Embodiment 22: The method of any one of Embodiments 1-21, wherein the cellulosic fiber or fabric is in the form of a thread, yam, knit, nonwoven, woven, terry, or velvet.

Embodiment 23: A method of cationizing a cellulosic fiber or fabric by graft polymerization, the cellulosic fiber or fabric comprising polysaccharide chains comprising a plurality of glucose residues having hydroxymethyl groups, the method comprising: contacting the cellulosic fiber or fabric with a solution comprising a cationic polymer to form an impregnated cellulosic fiber or fabric; contacting the impregnated cellulosic fiber or fabric with a solution comprising a thermal initiator; and curing the impregnated cellulosic fiber or fabric to form a cationized cellulosic fiber or fabric, wherein the cationized cellulosic fiber or fabric comprises cationic polymeric side chains covalently bonded to at least a portion of the hydroxymethyl groups present in the plurality of glucose residues.

Embodiment 24: The method of Embodiment 23, wherein the cationic polymer is a cationic polyacrylate, a cationic polymethacrylate, a cationic polyacrylamide, a cationic polymethacrylamide, or a combination thereof.

Embodiment 25: The method of Embodiment 23, wherein the cationic polymer is poly-diallyldimethyl ammonium chloride (poly-DADMAC).

Embodiment 26: The method of Embodiment 24 or 25, wherein the molecular weight range of the cationic polymer is from about 50,000 to about 750,000 daltons, or from about 100,000 to about 500,000 daltons.

Embodiment 27: The method of any one of Embodiments 23-26, wherein the thermal initiator is selected from the group consisting of sodium potassium persulfate, potassium persulfate, ammonium persulfate, ceric ammonium nitrate, azobisisobutyronitrile, 2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]dihydrochloride, 4,4′-Azobis(4-cyanovaleric acid), or 2,2′-Azobis[N-(2-carboxyethyl)-2-methylpropionamidine]tetrahydrate, organic peroxides, organic hydroperoxides, and combinations thereof.

Embodiment 28: The method of Embodiment 27, wherein the thermal initiator is sodium persulfate or potassium persulfate.

Embodiment 29: The method of any one of Embodiments 23-28, wherein contacting the cellulosic fiber or fabric with the cationic polymer comprises dipping the cellulosic fiber or fabric into the solution comprising the cationic polymer.

Embodiment 30: The method of any one of Embodiments 23-28, wherein contacting the cellulosic fiber or fabric with the cationic polymer comprises passing the cellulosic fiber or fabric through the solution comprising the cationic polymer in a continuous manner.

Embodiment 31: The method of Embodiment 29 or 30, further comprising mechanically removing a portion of the cationic polymer solution from the impregnated fibers or fabric.

Embodiment 32: The method of any one of Embodiments 29-31, wherein the contacting is repeated sequentially two or more times.

Embodiment 33: The method of any one of Embodiments 23-32, wherein contacting the cellulosic fiber or fabric with the solution comprising the cationic polymer is conducted at a temperature in a range from about 0° C. to about 50° C., and/or for a time period in a range from a few seconds to about 5 minutes.

Embodiment 34: The method of any one of Embodiments 23-33, further comprising, prior to contacting the cellulosic fiber or fabric with the solution comprising the thermal initiator, drying the impregnated cellulosic fiber or fabric.

Embodiment 35: The method of Embodiment 34, wherein the drying is conducted for a time period from about 2 minutes to about 8 minutes.

Embodiment 36: The method of Embodiment 34 or 35, wherein the drying is conducted at a temperature in a range from about 80° C. to about 130° C.

Embodiment 37: The method of any one of Embodiments 23-36, wherein contacting the cellulosic fiber or fabric with the solution comprising the thermal initiator comprises dipping the cellulosic fiber or fabric into the solution comprising the cationic polymer or passing the cellulosic fiber or fabric through the solution comprising the cationic polymer in a continuous manner.

Embodiment 38: The method of any one of Embodiments 23-37, further comprising mechanically removing a portion of the solution comprising the thermal initiator from the impregnated fibers or fabric.

Embodiment 39: The method of any one of Embodiments 23-38, further comprising, prior to the curing, drying the impregnated cellulosic fiber or fabric.

Embodiment 40: The method of Embodiment 39, wherein the drying is conducted for a time period from about 2 minutes to about 8 minutes.

Embodiment 41: The method of Embodiment 39 or 40, wherein the drying is conducted at a temperature in a range from about 80° C. to about 130° C.

Embodiment 42: The method of any one of Embodiments 23-41, wherein curing comprises exposing the impregnated cellulosic fiber or fabric to a temperature in a range from about 110° C. to about 180° C., such as about 130° C. to about 180° C., optionally for a time period from about 1 minute to about 3 minutes.

Embodiment 43: The method of any one of Embodiments 23-42, further comprising washing the cationized cellulosic fiber or fabric.

Embodiment 44: The method of any one of Embodiments 23-43, wherein the cellulosic fiber or fabric is cotton, a cotton blend, rayon, viscose, linen, modal, lyocell, or a combination thereof.

Embodiment 45: The method of any one of Embodiments 23-44, wherein the cellulosic fiber or fabric is in the form of a thread, yarn, knit, woven, terry, or velvet.

Embodiment 46: A cationized cellulosic fiber or fabric prepared by the method of any one of Embodiments 1-45.

Embodiment 47: A cationized cellulosic fiber or fabric comprising polysaccharide chains comprising a plurality of glucose residues having hydroxymethyl groups and cationic polymeric side chains covalently bonded to at least a portion of the hydroxymethyl groups present in the plurality of glucose residues, the cationic polymeric side chains comprising a polyacrylate, a polymethacrylate, a polyacrylamide, a polymethacrylamide, a poly-diallyldimethylammonium polymer, or a combination thereof.

Embodiment 48: The cationized cellulosic fiber or fabric of Embodiment 47, comprising a crosslinked polydiallyldimethylammonium polymer, said cationized cellulosic fiber or fabric comprising a structure according to Formula I:
wherein m is in a range from about 200 to about 500.

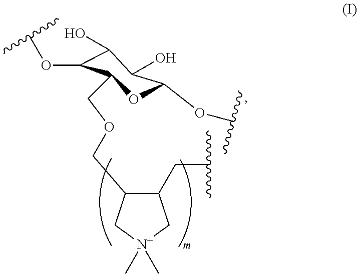

Embodiment 49: The cationized cellulosic fiber or fabric of Embodiment 48, wherein a weight average molecular weight of the cationic polymeric side chain is from about 10,000 to about 60,000.

Embodiment 50: The cellulosic fiber or fabric of Embodiment 47, comprising a polyacrylate or a polymethacrylate polymer, said cationized cellulosic fiber or fabric comprising a structure according to one of the following formulae:

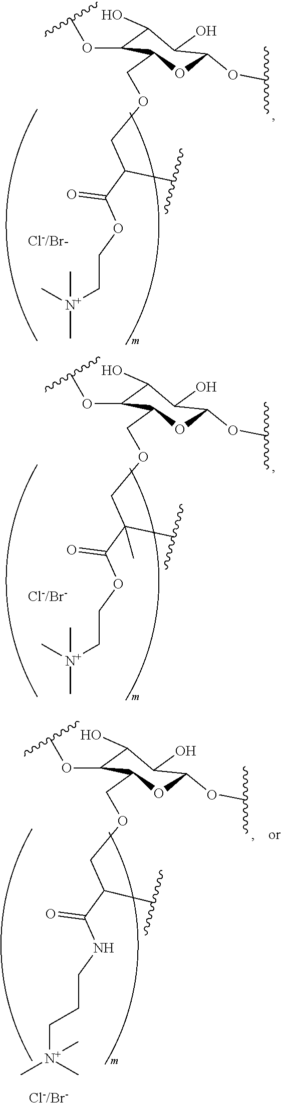

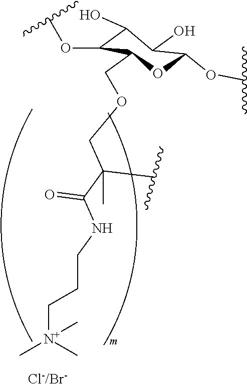

wherein m is in a range from about 200 to about 500

Embodiment 51: The cellulosic fiber or fabric of Embodiment 47, comprising a poly-tetraallyldimethylammonium polymer, said cationized cellulosic fiber or fabric comprising a structure according to one of the following formulae:

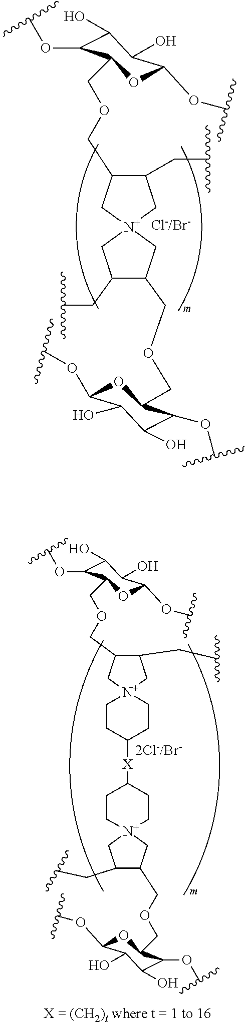

wherein m is in a range from about 200 to about 500.

Embodiment 52: A dyed cellulosic fiber or fabric comprising the cationized cellulosic fiber or fabric of any one of Embodiments 46-51, and further comprising a dye ionically bound thereto.

Embodiment 53: The dyed cellulosic fiber or fabric of Embodiment 52, having antimicrobial properties.

Embodiment 54: The dyed cellulosic fiber or fabric of Embodiment 53, which provides a reduction of about 99.99% or more of Gram-positive bacteria compared to an undyed, non-cationized cellulosic fiber or fabric control after 24 hours.

Embodiment 55: The dyed cellulosic fiber or fabric of Embodiment 53, which provides a reduction of about 99% or more of Gram-negative bacteria compared to an undyed, non-cationized cellulosic fiber or fabric control after 24 hours.

Embodiment 56: A method of dyeing a cationized cellulosic fiber or fabric, the cationized cellulosic fiber or fabric comprising polysaccharide chains comprising a plurality of glucose residues having hydroxymethyl groups and cationic polymeric side chains covalently bonded to at least a portion of the hydroxymethyl groups present in the plurality of glucose residues, the cationic polymeric side chains comprising a polyacrylate, a polyacrylamide, a polymethacrylate, a polymethacrylamide, a poly-diallyldimethylammonium, a poly-tetraallylammonium polymer, or a combination thereof, the method comprising contacting the cationized cellulosic fiber or fabric with a solution comprising a dye.

Embodiment 57: The method of Embodiment 56, wherein the solution is substantially free of alkaline salts.

Embodiment 58: The method of Embodiment 56, wherein the solution is substantially free of neutral and acidic salts.

Embodiment 59: The method of Embodiment 56, wherein the solution is substantially free of neutral, acidic, and alkaline salts.

Embodiment 60: The method of any one of Embodiments 56-59, wherein the solution has a pH in a range from about 6.8 to about 7.4.

Embodiment 61: The method of any one of Embodiments 56-60, wherein the dyeing is performed via exhaustion dyeing, a pad-steam-dry method, or foam dyeing method.

Embodiment 62: The method of any one of Embodiments 56-61, wherein dyeing comprises contacting the cationized cellulosic fiber or fabric with the solution comprising the dye in a foam dyeing machine.

Embodiment 63: The method of any one of Embodiments 56-62, wherein:
the dye solution after dyeing is clear and is a recyclable bath; and
when the water of the dye bath after dyeing is used to prepare another dye bath by adding the same amount of dye used in the fresh dye bath, the dyed cationized cellulosic fiber or fabric dyed using the recyclable bath has comparable color yield and/or colorfastness to a dyed cellulosic fiber or fabric prepared from the same cationized cellulosic fiber or fabric dyed in a corresponding fresh dye bath.

Embodiment 64: The method of any one of Embodiments 56-61, wherein dyeing comprises exhaustion dyeing, and wherein the dyed cellulosic fiber or fabric has a higher color yield and/or a comparable colorfastness as compared to a dyed cellulosic fiber or fabric prepared by exhaustion dyeing a cationized cellulosic fiber or fabric which has been cationized by treatment with 3-chloro-2-hydroxypropyltrimethylammonium chloride (CHPTAC).

Embodiment 65: The method of any one of Embodiments 56-61, wherein dyeing comprises contacting the cationized cellulosic fiber or fabric with dye using a pad-steam-dry method in the absence of salts, and wherein the dyed cellulosic fiber or fabric has a higher color yield compared to a non-cationized cellulosic fiber or fabric dyed using a pad-steam-dry method with salts, and/or as compared to a CHPTAC-treated cellulosic fiber or fabric dyed using a pad-steam-dry method in the absence of salts.

Embodiment 66: The method of any one of Embodiments 56-61, wherein dyeing comprises contacting the cationized cellulosic fiber or fabric with an acid dye or a direct dye, and wherein the dyed cellulosic fiber or fabric has comparable colorfastness to a dyed cellulosic fiber or fabric prepared by acid or a direct dyeing a cationized cellulosic fiber or fabric prepared by treatment with CHPTAC.

Embodiment 67: A dyed, cationized cellulosic fiber or fabric prepared by the method of any one of Embodiments to 56-66.

Embodiment 68: A method of dyeing a cationized cellulosic fiber or fabric, comprising cationizing a cellulosic fiber or fabric by graft polymerization according to the method of any one of Embodiments 1 to 45, and contacting the cationized cellulosic fiber or fabric with a solution comprising a dye, such as by any method set forth in Embodiments 56 to 66.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

### BRIEF DESCRIPTION OF THE DRAWINGS

In order to provide an understanding of aspects of the technology, reference is made to the appended drawings, which are not necessarily drawn to scale. The drawings are exemplary only and should not be construed as limiting the technology. The disclosure described herein is illustrated by way of example and not by way of limitation in the accompanying drawings.

FIG. 1 is a graphical illustration showing the color yield (expressed as color strength, absorption coefficient/scattering coefficient (K/S)) of untreated cotton, CHPTAC-treated cotton and cotton cationized by graft polymerization of DADMAC when dyed with 4% owf REMAZOL® Deep Black GWF and 5.5% of Everzol Black B H/C according to a non-limiting embodiment of the disclosure.

FIG. 2 is a graphical illustration showing color yield (expressed as color strength, K/S) of untreated cotton, CHPTAC-treated cotton and cotton cationized by graft polymerization of DADMAC when dyed with 5.5% REMAZOL® Brilliant Yellow 3GL and 5.5% Levafix Yellow CA Gran according to a non-limiting embodiment of the disclosure.

FIG. 3 is a graphical illustration of colorfastness (expressed in grey scale) to dry crocking of dyed untreated cotton, dyed CHPTAC-treated cotton and dyed cotton cationized by graft polymerization of DADMAC according to a non-limiting embodiment of the disclosure.

FIG. 4 is a graphical illustration of colorfastness (expressed in grey scale) to wet crocking of dyed untreated cotton, dyed CHPTAC-treated cotton and dyed cotton cationized by graft polymerization of DADMAC according to a non-limiting embodiment of the disclosure.

FIG. 5 is a graphical illustration of colorfastness (expressed in grey scale) to laundering of dyed untreated cotton, dyed CHPTAC-treated cotton and dyed cotton cationized by graft polymerization of DADMAC according to a non-limiting embodiment of the disclosure.

FIG. 6 is a graphical illustration of colorfastness (expressed in grey scale) to light of dyed untreated cotton, dyed CHPTAC-treated cotton and dyed cotton cationized by graft polymerization of DADMAC after 20 hours exposure according to a non-limiting embodiment of the disclosure.

FIG. 7 is a graphical illustration is a graph of colorfastness (expressed in grey scale) to light of dyed untreated cotton, dyed CHPTAC-treated cotton and dyed cotton cationized by graft polymerization of DADMAC after 40 hours exposure according to a non-limiting embodiment of the disclosure.

FIG. 8 is a graphical illustration is a graph of color yield (expressed as color strength, K/S) of cotton cationized by graft polymerization of DADMAC dyed using fresh water and recycled dye bath according to a non-limiting embodiment of the disclosure.

FIG. 9 is a graphical illustration of colorfastness (expressed in grey scale) to crocking of cotton cationized by graft polymerization of DADMAC dyed using zero alkali according to a non-limiting embodiment of the disclosure.

FIG. 10 is a graphical illustration of colorfastness (expressed in grey scale) to crocking of cotton cationized by graft polymerization of DADMAC dyed using alkali according to a non-limiting embodiment of the disclosure.

FIG. 11 is a graphical illustration is a graph of colorfastness (expressed in grey scale) to laundering of cotton cationized by graft polymerization of DADMAC dyed using fresh water and recycled dye bath according to a non-limiting embodiment of the disclosure.

FIG. 12 is a graphical illustration of colorfastness (expressed in grey scale) to light of cotton cationized by graft polymerization of DADMAC dyed using zero alkali according to a non-limiting embodiment of the disclosure.

FIG. 13 is a graphical illustration of colorfastness (expressed in grey scale) to light of cotton cationized by graft polymerization of DADMAC dyed using alkali according to a non-limiting embodiment of the disclosure.

FIG. 14 is a graphical illustration of color yield (expressed as color strength, K/S) of untreated cotton, CHPTAC-treated cotton and cotton cationized by graft polymerization of DADMAC when dyed with REMAZOL® Deep Black GWF and Everzol Black B H/C according to a non-limiting embodiment of the disclosure.

FIG. 15 is a graphical illustration of color yield (expressed as color strength, K/S) of untreated cotton, CHPTAC-treated cotton and cotton cationized by graft polymerization of DADMAC when dyed with REMAZOL® Brilliant Yellow 3GL and Levafix Yellow CA Gran according to a non-limiting embodiment of the disclosure.

FIG. 16 is a graphical illustration of colorfastness (expressed in grey scale) to dry crocking of dyed untreated cotton, dyed CHPTAC-treated cotton and dyed cotton cationized by graft polymerization of DADMAC according to a non-limiting embodiment of the disclosure.

FIG. 17 is a graphical illustration of colorfastness (expressed in grey scale) to wet crocking of dyed untreated cotton, dyed CHPTAC-treated cotton and dyed cotton cationized by graft polymerization of DADMAC according to a non-limiting embodiment of the disclosure.

FIG. 18 is a graphical illustration of colorfastness (expressed in grey scale) to laundering of dyed untreated cotton, dyed CHPTAC-treated cotton and dyed cotton cationized by graft polymerization of DADMAC according to a non-limiting embodiment of the disclosure.

FIG. 19 is a graphical illustration of colorfastness (expressed in grey scale) to light of dyed untreated cotton, dyed CHPTAC-treated cotton and dyed cotton cationized by graft polymerization of DADMAC after 20 hours exposure according to a non-limiting embodiment of the disclosure.

FIG. 20 is a graphical illustration of colorfastness (expressed in grey scale) to light of dyed untreated cotton, dyed CHPTAC-treated cotton and dyed cotton cationized by graft polymerization of DADMAC after 40 hours exposure according to a non-limiting embodiment of the disclosure.

FIG. 21 is a graphical illustration of color yield (expressed as color strength, K/S) of CHPTAC-treated cotton and cotton cationized by graft polymerization of DADMAC when dyed with Erionyl Yellow A-3G and Permalite Yellow 2RLSW NEW according to a non-limiting embodiment of the disclosure.

FIG. 22 is a graphical illustration of colorfastness (expressed in grey scale) to crocking, laundering and light of CHPTAC treated cotton and cotton cationized by graft polymerization of DADMAC when dyed with Erionyl Yellow A-3G according to a non-limiting embodiment of the disclosure.

FIG. 23 is a graphical illustration of colorfastness (expressed in grey scale) to crocking, laundering and light of CHPTAC-treated cotton and cotton cationized by graft polymerization of DADMAC when dyed with Permalite Yellow 2RLSW NEW according to a non-limiting embodiment of the disclosure.

FIG. 24 is a MALDI-TOF mass spectrum of a poly-DADMAC polymer excised from a graft polymerized cotton according to a non-limiting embodiment of the disclosure.

FIG. 25 is an XPS spectrum of a DADMAC-cationized cotton according to a non-limiting embodiment of the disclosure.

FIG. 26 is an XPS spectrum of a DADMAC-cationized cotton according to a non-limiting embodiment of the disclosure.

FIG. 27 is an XPS spectrum of a DADMAC-cationized cotton according to a non-limiting embodiment of the disclosure.

FIG. 28 is an XPS spectrum of a DADMAC-cationized cotton according to a non-limiting embodiment of the disclosure.

FIG. 29 is graphical illustration of color yield (expressed as color strength, K/S) for a series of dyed, DADMAC-cationized cottons according to non-limiting embodiments of the disclosure.

FIG. 30 is graphical illustration of color yield (expressed as color strength, K/S) for a dyed, DADMAC-cationized cotton according to non-limiting embodiments of the disclosure and a reference dyed, non-cationized cotton.

### DETAILED DESCRIPTION

Disclosed herein are methods for cationizing cellulosic fibers by graft polymerization of the cellulosic fibers with a cationic alkenyl monomer in the presence of a thermal initiator. Further disclosed are methods of dyeing such cationized cellulosic fibers, and undyed and dyed cationized cellulosic fibers prepared by the disclosed methods. The various steps of the methods and properties of the undyed and dyed cationized cellulosic fibers are described further herein below.

### Definitions

With respect to the terms used in this disclosure, the following definitions are provided. This application will use the following terms as defined below unless the context of the text in which the term appears requires a different meaning.

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “one or more” when used in this application in reference to a list or group of one or more items (e.g., one or more chemical elements or ions), can refer to any one of said items, a combination or mixture of any two of said items, a combination or mixture of any three of said items, a combination or mixture of any four of said items etc., including a combination or mixture of all listed items. The combinations of chemical components (e.g., ions) can include any ratio of the components, unless specified otherwise.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, a “monomer” refers to a molecule that can undergo polymerization, thereby contributing constitutional units, i.e., an atom or group of atoms, to the essential structure of a polymer.

As used herein, the term “polymer” refers to a molecule of high relative molecular mass, the structure of which comprises multiple repetition of units derived from monomers and can include both oligomeric molecules and molecules with a larger number of repetitive units.

As used herein, a “graft polymer” refers to a macromolecule comprising one or more species of polymer connected to the main chain (i.e., cellulose) as a side chain or chains, wherein the side chain(s) comprises constitutional or configurational features that differ from those in the main chain. In the present disclosure, the macromolecule is a cellulosic material having grafted thereon a polymer comprising multiple cationic monomer units as described herein.

The term “alkenyl” as used herein refers to a straight or branched hydrocarbon group comprising carbon and hydrogen atoms and containing at least one carbon-carbon double (sp²-sp²) bond. The alkenyl group is attached to the rest of the molecule (i.e., cationic monomer) through one or more single bonds to form, for example, vinyl, allyl, or acryloyl moieties (i.e., vinyl, allyl, and acryloyl moieties comprise an alkenyl group).

The term “vinyl” as used herein refers to a —CH═CH₂ moiety.

The term “allyl” as used herein refers to a —CH₂CH═CH₂ moiety. An allyl moiety comprises a vinyl (—CH═CH₂) moiety attached to a methylene (—CH₂) group.

The term “acryloyl” as used herein refers to a CH₂═CH(C═O)— or CH₂═CCH₃(C═O)— (methacryloyl) moiety. An acryloyl moiety comprises a vinyl moiety connected to a carbonyl (C═O) moiety. A methacryloyl moiety comprises a vinyl moiety connected to a methyl group and a carbonyl moiety. For avoidance of doubt, reference herein to “acryloyl” further is intended to include methacryloyl. As used herein in reference to a monomer, the terms “acryloyl moiety” and “methacryloyl moiety” refer to cationic monomers comprising an acryloyl or methacryloyl moiety, respectively, such as acrylates and methacrylates (i.e., acrylic and methacrylic esters), and acrylamides and methacrylamides (i.e., acrylic and methacrylic amides).

As used herein, the term “color yield” refers to a total value for color strength, defined as the ratio of the absorption coefficient to the scattering coefficient (K/S).

### Method of Cationizing Cellulosic Fibers by Graft Polymerization

In one aspect is provided a method of cationizing cellulosic fibers or fabrics by graft polymerization. The method generally comprises contacting cellulosic fibers, or fabrics made therefrom, with a cationic alkenyl monomer in the presence of a thermal initiator. The various materials and conditions utilized in the method are described further herein below.

Cotton is a staple fiber obtained from the cotton plants of the genus Gossypium. The fiber is almost pure cellulose. In turn, cellulose is a linear polysaccharide consisting of from several hundred to many thousands of β(1→4) linked D-glucose units and having the general chemical formula (C₆H₁₀O₅)ₙ where n refers to the number of repeating glucose units. In cellulose obtained from plants, the number n may range from 800 to 10,000. Cellulose may be graphically represented by the corresponding formula:

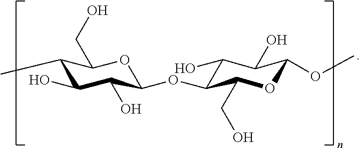

Each glucose residue comprises three free hydroxyl groups: one at the 2-position relative to the anomeric center, one at the 3-position relative to the anomeric center, and one comprising the hydroxymethyl group at the 5-position relative to the anomeric center.

### Cationized Cellulosic Fibers

Cationized cellulosic fibers refers to cellulosic fibers (e.g., cotton fiber or fabrics made therefrom) that have been chemically modified to possess a permanent positive (cationic) charge. Cationizing is performed to enhance certain properties, such as to increase the number of sites in the fiber available for dyeing, to enhance percent exhaustion in dyeing, and to effectively produce dark shades when dyed using exhaustion, foam, cold-pad batch, or pad-steam-dry methods. Advantages of cationized cellulosic fibers in the dyeing process include a reduction in the amount of wastewater produced, reduced dye time, reduced dye quantities, and the potential for reduction or elimination of salts and alkali in the dye process. These advantages lead to cost savings, energy savings, and reduced environmental impact.

Despite the desirability of cationized cellulosic fibers, present cationization methods suffer from certain liabilities. As described above, typical cationization methods utilize reaction of 3-chloro-2-hydroxypropyltrimethylammonium chloride (CHPTAC) with free hydroxyl groups present in the glucose units forming the cellulose chains comprising the cellulosic fibers. Processes utilizing CHPTAC produce toxic intermediates and byproducts, require use of large reagent excess, and the cationized cellulosic fibers product requires extensive washing and acid neutralization. Accordingly, provided herein is an alternative cationization method which has numerous advantages over known methods. For example, certain embodiments of the disclosed method are rapid, efficient, simple, and environmentally much more benign than prior methods.

In the disclosed method, at least a portion of the free glucose residue hydroxy groups, and specifically at least a portion of the hydroxy groups comprising the hydroxymethyl groups of the glucose units within the cellulosic fibers or fabric, are cationized by graft polymerizing a monomer onto said free primary hydroxy groups. The monomer comprises one or more alkenyl groups (e.g., vinyl, allyl, acryloyl, methacryloyl) and a cationic group, referred to herein as a cationic alkenyl monomer. Alternatively, in certain embodiments, the monomer is a pre-polymerized cationic polymer such as poly-dimethyldiallylammonium chloride (poly-DADMAC); this variation is described further herein below.

The graft polymerization is performed under free-radical conditions using a thermal initiator. In certain embodiments, the graft polymerization reaction does not produce toxic or odoriferous intermediates or byproducts and the cationized cellulosic fibers produced by such reaction do not require neutralization or extensive washing. Further, in some embodiments, the graft polymerization can be performed using a pad-dry-cure or exhaustion method, in contrast to cationization with CHPTAC, which is performed using a cold pad-batch method and takes at least 24 hours.

### Cationic Alkenyl Monomer

The disclosed method generally utilizes graft polymerization of a cationic alkenyl monomer onto free hydroxy groups comprising the cellulosic fibers. Various cationic alkenyl monomers may be utilized in the disclosed method. Generally, the cationic group to be grafted comprises a quaternary ammonium moiety or other permanently charged cationic group. In particular embodiments, the cationic group is a trimethylammonium moiety, charge balanced with a counterion such as a halide (e.g., chloride, bromide, or iodide). In some embodiments, the cationic alkenyl monomer comprises one or more alkenyl groups, such as one or more vinyl groups, one or more allyl groups, or one or more acrylate or acrylamide groups.

In some embodiments, the cationic alkenyl monomer is an acryloxy alkyl trimethylammonium salt, a methacryloxy alkyl trimethylammonium salt, an acrylamido alkyl trimethylammonium salt, or a methacrylamido alkyl trimethylammonium salt. The counterion in such salts may be chloride, bromide, or iodide. In some embodiments, the cationic alkenyl monomer is 2-(acryloyloxy)ethyl trimethylammonium chloride (AOETMAC), 2-(methacryloyloxy)ethyl trimethylammonium chloride (MOETMAC), (3-acrylamidopropyl)trimethylammonium chloride (AAPTMAC), or [3-(methylacryloylaminopropyl]trimethylammonium chloride (MAPTMAC).

In some embodiments, the cationic alkenyl monomer is an allylic cationic monomer. In some embodiments, the cationic alkenyl monomer is diallyl dimethyl ammonium chloride, bromide, or iodide. In some embodiments, the cationic alkenyl monomer is diallyl dimethyl ammonium chloride (DADMAC), tetraallyl ammonium bromide (TAAB), tetraallyl ammonium chloride (TAAC), N,N,N′,N′-tetraallyl trimethylene dipiperidine dibromide (TAMPB) or N,N,N′,N′-tetraallyl trimethylene dipiperidine dichloride (TAMPC). Structures of representative alkenyl monomers include, but are not limited to:

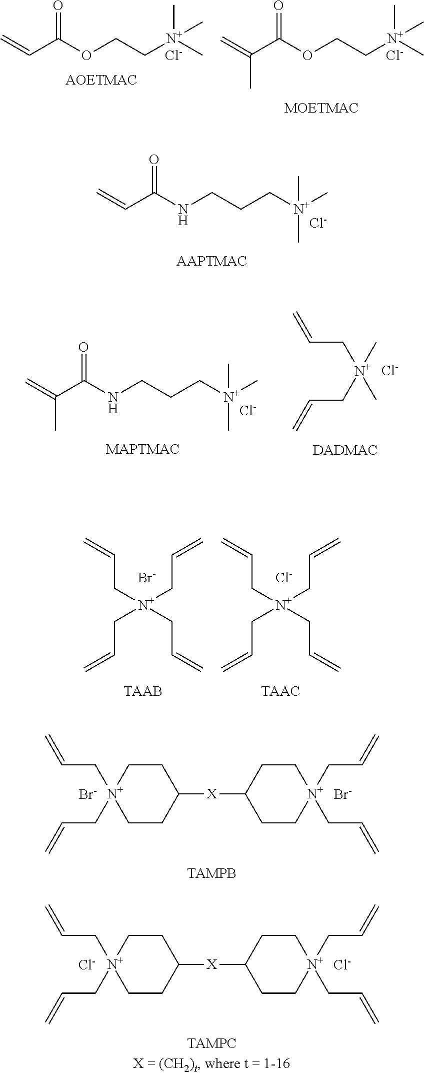

In particular embodiments, the cationic alkenyl monomer is DADMAC. This monomer is particularly advantageous as the cationic alkenyl monomer by virtue of its low toxicity; it is generally regarded as safe for humans and other organisms present in the environment and is inexpensive and readily available commercially. Further, poly-DADMAC is a polymer approved by the United States Food and Drug administration in the treatment of potable water treatment. See References 39-41.

In presence of a thermal initiator, DADMAC not only generates a covalent bond with cellulose hydroxyl groups but may also polymerize to form a cross-linked network. A non-limiting illustration of the reaction of DADMAC with an individual glucose residue hydroxymethyl group of the cellulose polymer in a cellulosic fiber is provided as Scheme 2.

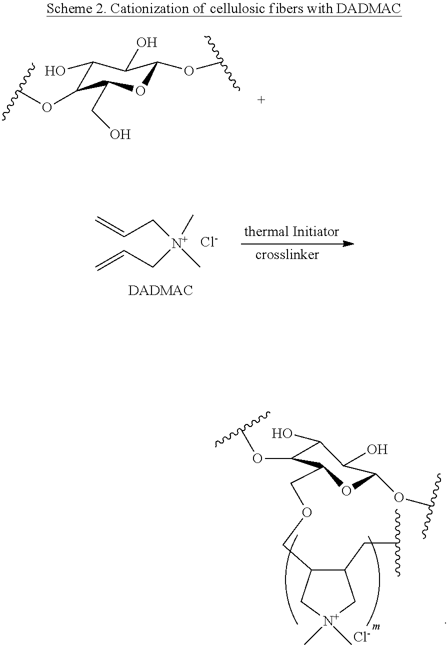

With reference to Scheme 2, following the graft polymerization reaction, cationized cellulosic fibers are obtained comprising repeating N,N-dimethylpyrrolidine residues (“polydiallyldimethylammonium” or “poly-DADMAC”), where the variable m indicates the number of repeating units. The value of m may vary but is generally on the order of about 20 to about 200. Particularly, the molecular weight of the poly-DADMAC chain produced according to the disclosed method is on the order of about 10,000 to about 60,000 daltons, such as from about 25,000 to about 40,000 daltons. As used herein, reference to “molecular weight” means the weight average molecular weight (M_{w}), calculated from the weight fraction distribution of the polymers. However, lower and higher molecular weights of poly-DADMAC and other cationic polymers covalently bonded to the cellulosic material can be achieved depending on the molar ratio of initiator, monomer, crosslinker, and curing time, each of which is described further herein below.

Molecular weights of cationic polymers of the disclosure may be determined by excision of the polymer from the modified cellulosic material by an appropriate enzyme (e.g., a cellulase), followed by analysis of the polymer by e.g., matrix-assisted laser desorption/ionization-time-of-flight mass spectroscopy (MALDI-TOF MS). It is noted that Scheme 2 is simplified and is not intended to be limiting with respect to the product structure and does not illustrate crosslinking or other possible isomeric products which may exist in cationized cellulosic fibers produced by the disclosed method.

In some embodiments, the cationic alkenyl monomer is 2-(acryloyloxy)ethyl trimethylammonium chloride (AOETMAC), 2-(methacryloyloxy)ethyl trimethylammonium chloride (MOETMAC), (3-acrylamidopropyl)trimethylammonium chloride (AAPTMAC), or [3-(methylacryloylaminopropyl]trimethylammonium chloride (MAPTMAC)).

In some embodiments, the cationic alkenyl monomer is TAAB, TAAC, TAMPB, or TAMPC.

### Initiator

The method generally comprises contacting cotton with a cationic alkenyl monomer in the presence of an initiator and a crosslinker. However, as described below, the crosslinker may be omitted in the case of grafting pre-formed cationic polymers onto the cellulosic fibers or fabric. The initiator serves to generate radicals to initiate the graft polymerization reaction, and any radical initiator having adequate solubility and capable of providing radicals under the desired conditions may be utilized. In some embodiments, the initiator is a thermal initiator, meaning it generates free radicals when heated to or above a particular temperature or range of temperatures. Examples of suitable thermal initiators include, but are not limited to, persulfates, nitrates, azo compounds, peroxides, hydroperoxides, and peracids. In some embodiments, the thermal initiator is an alkali metal or ammonium persulfate or a transition metal nitrate. In some embodiments, the thermal initiator is potassium persulfate, ammonium persulfate, or ceric ammonium nitrate. In some embodiments, the thermal initiator is sodium persulfate. In some embodiments, the thermal initiator is (2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]-dihydrochloride, 4,4′-Azobis(4-cyanovaleric acid), or 2,2′-Azobis[N-(2-carboxyethyl)-2-methylpropionamidine]tetrahydrate. Other potential initiators include organic peroxides (e.g., benzoyl peroxide), hydroperoxides (e.g., t-butyl hydroperoxide), and peracids (e.g., peracetic acid).

The quantity of thermal initiator may vary. In some embodiments, the quantity of initiator is determined relative to the amount of monomer utilized. In some embodiments, the amount of initiator is in a range from about 0.05 to about 3.0 wt %, relative to the weight of the monomer.

### Crosslinker

The method generally comprises contacting the cellulosic fiber with a crosslinking agent in order to crosslink the cationic polymer chains, the cationic polymer with additional cellulosic chains, and/or the cellulose residues comprising the cellulosic fibers. Cross-linking stabilizes cellulosic fibers by forming bridging linkages between cellulose chains. Cross-linking adjacent cellulose chains may improve wrinkle resistance, crease recovery and/or imbue the cellulosic fiber with antimicrobial, flame retardant, water repellant, or other desirable properties, depending on the chemistry of the crosslinker. Generally, crosslinking agents react with free radicals on the growing chain of cationic polymer and radicals at the free primary hydroxyl groups of the glucose units comprising the cellulose chains of the cellulosic fiber, linking the chains together in two- or three-dimensional arrays. Suitable crosslinkers include diacrylate, triacrylate, tetraacrylate, bisacrylamide, trisacrylamide and tetrakisacrylamide monomers. In some embodiments, the cross linker is N,N′-methylenebisacrylamide (MBA), pentaerylthritol triacrylate, N-[Tris(3-acrylamidopropoxymethyl)methyl]-acrylamide, a polyethylene glycol diacrylate, tetra(ethylene glycol) diacrylate, or pentaerythritol tetraacrylate. In some embodiments, the crosslinker is MBA. In some embodiments, the crosslinker is a polyethylene glycol diacrylate or a derivative thereof.

In other embodiments, the crosslinking function is provided solely or in part by the cationic alkenyl monomer. For example, in some embodiments, the cationic alkenyl monomer is a tetraallyl cationic monomer capable of crosslinking two or more polymer and/or cellulose chains (e.g., TAAB, TAAC, TAMPB, or TAMPC). In such embodiments, no additional crosslinker is required or added. Similarly, no crosslinker is required when grafting pre-formed cationic polymers onto the cellulosic fibers or fabric, as described below.

### Method of Contacting

The method generally comprises contacting the cellulose fibers or fabric with the cationic alkenyl monomer, the thermal initiator, and the crosslinker. These four components may be brought into contact with the fibers or fabric in various ways. Typically, the monomer, initiator, and crosslinker are present in a solution in water, and the fibers or fabric are contacted with the aqueous solution such that the solution is impregnated into the fibers or fabric. In some embodiments, the contacting is performed by dipping or passing the fibers or fabric through the solution. In some embodiments, the contacting is performed by converting the solution into a foam in the presence of one or more foaming agents, and the foam applied to the fibers or fabric. In some embodiments, such foam formation and application is performed using a foaming machine.

Each of the components contacted with the cellulose fibers (i.e., the monomer, the thermal initiator, and the crosslinker) can be contacted with the cellulose fibers in combination (or partial combination) or separately. For example, the monomer, thermal initiator, and crosslinker can be applied to the cellulose fibers using a single solution, or applied using separate, sequential solutions, each containing at least one of the treatment components.

The solution or foam may be held at a range of temperatures during the contacting. Conveniently, the solution is at the temperature of the surroundings where the contacting is taking place (i.e., ambient or room temperature). Suitable ambient temperatures may range from about 10° C. to about 50° C., such as about 15, about 20, or about 25° C.

The concentrations of each of the monomer, initiator, and the crosslinker present in the solution may vary. In some embodiments, the solution comprises the initiator in an amount in a range from about 0.1 to about 5% by weight, such as from about 0.3 to about 4%, or from about 0.5 to about 3% by weight, based on the weight of bath. In some embodiments, the concentration of the initiator is determined relative to the quantity of monomer present, as described above. In some embodiments, the solution comprises the monomer in an amount in a range from about 5 to about 20% by weight, such as from about 6 to about 18%, or from about 8 to about 20% by weight, based on the weight of bath. In some embodiments, the solution comprises the crosslinker in an amount in a range from about 0.5 to about 3% by weight, such as from about 1 to about 2% by weight, based on the weight of bath. In some embodiments, the solution is free of crosslinker.

The fibers or fabric may be contacted with the solution for various periods of time, depending on the specific material, the concentration of reactants in the solution, and the like. Generally, the contacting is performed for a period sufficient to partially or fully saturate the fibers or fabric with the solution. In some embodiments, the fibers or fabric are contacted with the solution for a period of time from a few seconds to about 5 minutes. In some embodiments, the wet weight of the impregnated material is greater than the weight of the initial, dry material by 50 to 100%, such as about 60 to about 95%. In some embodiments, any excess solution is at least partially removed mechanically, such as by a pressing action. Conveniently, the contacting may be performed in a padding machine, in which the fibers or fabric are flowed through the solution in a bath format, then passed through one or more rollers configured to wring excess solution from the fibers or fabric. The contacting may be performed in a single pass, referred to as 1 dip, 1 nip, or may be performed successively in multiple sequential cycles (e.g., 2 dips, 2 nips, or 3 dips, 3 nips). Other methods of contacting are possible as known in the art, and such alternatives are contemplated herein.

### Drying and Curing

Following the contacting, the impregnated fibers or fabric are exposed to conditions suitable to induce and complete graft polymerization. Generally, the graft polymerization requires exposure of the impregnated fabric to an elevated temperature suitable to produce free radicals from the initiator and to initiate and propagate graft polymerization of the cationic alkenyl monomer to the desired extent. The stage at which the graft polymerization is performed is referred to herein as curing. The extent of polymerization (i.e., the polymer chain length and consequently the polymer molecular weight) is determined at least in part by the length of time the impregnated fibers or fabric are exposed to the elevated temperature. Accordingly, the curing time and temperature may vary depending on the initiator, the alkenyl monomer, and the desired degree of polymerization, as well as the concentration of the reactants present in the impregnation solution. In some embodiments, the impregnated fibers or fabric are dried prior to curing. In some embodiments, the impregnated fibers or fabric are dried and cured simultaneously.

In some embodiments, the impregnated fiber or fabric are dried at a first temperature for a first period of time, followed by curing at a second temperature for a second period of time. In some embodiments, the first temperature is about 80° C. to about 130° C. (e.g., about 80° C., about 90° C., about 100° C., about 110° C., about 120° C. or about 130° C.). In some embodiments, the first period of time is about 2 minutes to about 8 minutes (e.g., about 2, 3, 4, 5, 6, 7, or about 8 minutes).

In some embodiments, the second temperature is about 110° C. to about 180° C. (e.g., about 130° C., about 140° C., about 150° C., about 160° C., about 170° C., or about 180° C.). In some embodiments, the second temperature is about 130° C. or higher, or about 140° C. or higher, or about 150° C. or higher, or about 160° C. or higher. In some embodiments, the second period of time is about 1 minute to about 3 minutes (e.g., about 60 seconds, about 75 seconds, about 90 seconds, about 105 seconds, about 120 seconds, about 135 seconds, about 150 seconds, about 165 seconds, or about 180 seconds).

In some embodiments, the impregnated fiber or fabric are dried and cured simultaneously, for example, at a temperature from about 80° C. to about 180° C., for a period of time in a range from about 0.5 to about 8 minutes.

The foregoing drying and curing may be performed by any suitable method. In some embodiments, the fiber or fabric is heated in an oven, for example, while moving through an oven in a continuous process. Suitable apparatus for such heating are known in the art and referred to as tenter frames.

### Washing

In some embodiments, the cationized cellulosic fiber or fabric is washed following the completion of the curing. Such washing may be performed to remove ungrafted polymer and/or thermal initiator or decomposition products thereof. In some embodiments, washing comprises a single water rinse. In some embodiments, washing comprises two or more water rinses, such as two or three rinses. The rinses may be performed at temperatures in a range from about 10° C. to about 80° C., such as from about 25 to about 70° C. The rinse(s) may be performed for various periods of time, such as from about 5 to about 10 minutes. Following the optional washing, the cationized fiber or fabric may be treated to remove the wash water, such as by compacting through rollers, heat drying, or a combination thereof.

Grafting of Polymers onto Cellulosic Fibers and Fabric

In an alternative embodiment, a pre-prepared cationic polymer may be grafted onto the cellulosic fibers or fabric to prepare cationized cellulosic fibers or fabric. The cationized cellulosic fibers or fabrics prepared in this manner comprise a cationic polymer of higher molecular weight covalently bonded to the cellulose primary hydroxy groups relative to those obtained from a corresponding monomer. For example, cationic polymers having molecular weights in the range of up to 100,000, 200,000, 300,000, 400,000, or even 500,000 daltons (e.g., about 50,000 to about 750,000 daltons or about 100,000 to about 400,000 daltons or about 150,000 to about 300,000 daltons) may be utilized for radical graft polymerization in the presence of a thermal initiator. Suitable cationic polymers include poly-diallyldialkyl ammonium polymers, poly-tetraallyl ammonium polymers, polyacrylates, polymethacrylates, polyacrylamides, and polymethacrylamides. In some embodiments, the cationic polymer is a polymer of any of the cationic monomers noted herein above. In some embodiments, the method utilizes a poly-diallyldialkyl ammonium polymer such as poly-diallyldimethyl ammonium chloride (poly-DADMAC). Solutions of poly-DADMAC of varying molecular weights (e.g., from 100,000 to 500,000) are commercially available. Notably, the grafting method as disclosed herein, when conducted with a cationic polymer such as poly-DADMAC, does not require a crosslinker to provide a cationized cellulosic fiber or fabric having the desired incorporation of cationic polymer and associated properties.

In this method, the initiator and the conditions described with respect to graft polymerization of alkenyl monomers are generally the same, however, the manner in which the contacting is altered. In certain embodiments, the cationic polymer and the thermal initiator are applied to the cellulosic fiber separately (e.g., in separate solutions). For example, the cellulosic fibers or fabric are contacted with a solution comprising the cationic polymer first, at least a portion of the solution is mechanically removed, and then the impregnated fabric is optionally dried, then contacted with the thermal initiator. Following the contacting with the thermal initiator, the method proceeds as described above with respect to graft polymerization of cationic alkenyl monomers.

### Cationized Cellulosic Fiber or Fabric Structures and Properties

In another aspect is provided a cationized cellulosic fiber or fabric prepared according to the disclosed methods. As described herein above, the cationized cellulosic fiber or fabric comprises cationic polymer sides chains covalently bonded to oxygen atoms on at least a portion of the hydroxymethyl groups comprising the cellulose chains comprising the cellulosic fibers or fabric. The structure and molecular weight of such polymer chains, along with the extent of any crosslinking present, may vary as described herein above.

In some embodiments, the cationized cellulosic fiber or fabric comprises a crosslinked polydiallyldimethylammonium polymer, said cationized cellulosic fiber or fabric comprising a structure according to Formula I:

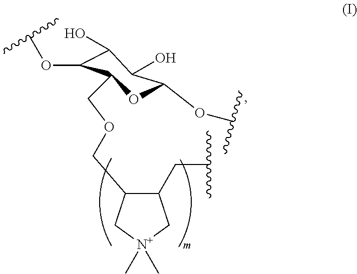

wherein m is in a range from about 200 to about 500. The value of m may vary but is generally on the order of about 200 to about 500, such that the molecular weight is in a range from about 10,000 to about 50,000, or from about 20,000 to about 40,000.

It is noted that this structural depiction is simplified and not intended to be limiting with respect to the actual product structure as crosslinking is not illustrated. One of skill in the art will understand that the structure of the crosslinked cationic polymer network grafted onto the cellulose chain will vary depending on the specific crosslinker used, the concentration thereof, and graft polymerization conditions. Hence, the both the structure and the physical properties of a DADMAC polymer network crosslinked with a diacrylate-based crosslinker would be unique and different from a DADMAC polymer network crosslinked with e.g., MBA, further resulting in different properties for dyeing.

A non-limiting, simplified representative structure depicting a cationized cellulosic fiber or fabric of the disclosure, comprising a DADMAC polymer network crosslinked with a polyethylene glycol diacrylate-based crosslinker, is provided as Formula II:

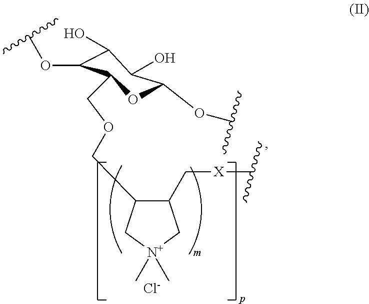

wherein:
X is —CH₂CH₂COO(CH₂CH₂O)_{y}OCCH₂CH₂—;
y≥4;
p is in a range from about 200 to about 500; and
a ratio of m:X is in a range from about 10:0.5 to about 10:3.0.
   Formula II is provided merely to illustrate, in simplified form, the type of structure resulting from the graft polymerization of DADMAC and a polyethylene glycol diacrylate-based crosslinker. However, Formula II does not illustrate the actual crosslinking between chains, which one of skill in the art would recognize to be present. It is noted that group X is not intended to be limited solely to this type of diacrylate crosslinker; as described herein, other types of crosslinker are contemplated, and any crosslinker curable by exposure to e.g., radiation, such as ultraviolet or other electromagnetic radiation, or elevated temperature may be incorporated in the cationized cellulosic material. It is further noted that the nature of the crosslinked polymer network depicted for poly-DADMAC above also applies to all other cationic alkenyl monomers described herein (e.g., acryloxy alkyl trimethylammonium salts, methacryloxy alkyl trimethylammonium salts, acrylamido alkyl trimethylammonium salts, methacrylamido alkyl trimethylammonium salts, etc.).

In some embodiments, the cationized cellulosic fiber or fabric comprises a polyacrylate or a polymethacrylate polymer, said cationized cellulosic fiber or fabric comprising a structure according to one of the following formulae:

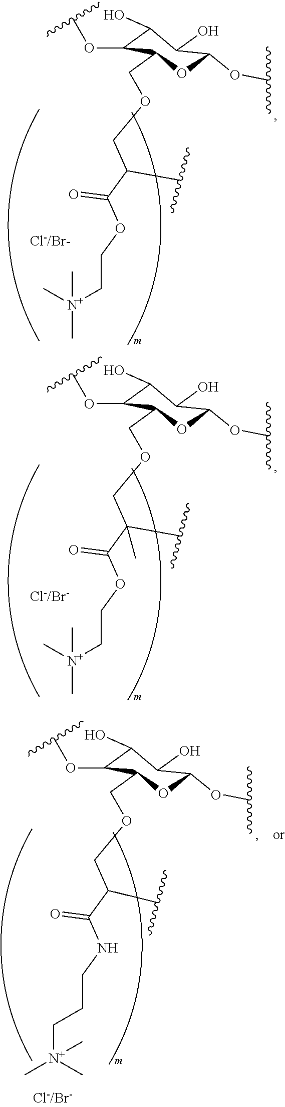

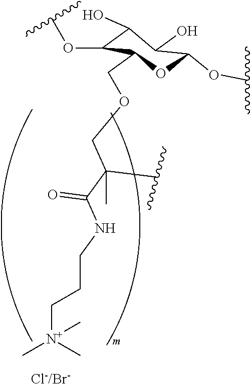

wherein m is in a range from about 200 to about 500. Again, such structural depictions are simplified and not intended to be limiting with respect to the actual product structure as crosslinking is not illustrated.

In some embodiments, the cationized cellulosic fiber or fabric comprises a poly-tetraallyldimethylammonium polymer, said cationized cellulosic fiber or fabric comprising a structure according to one of the following formulae:

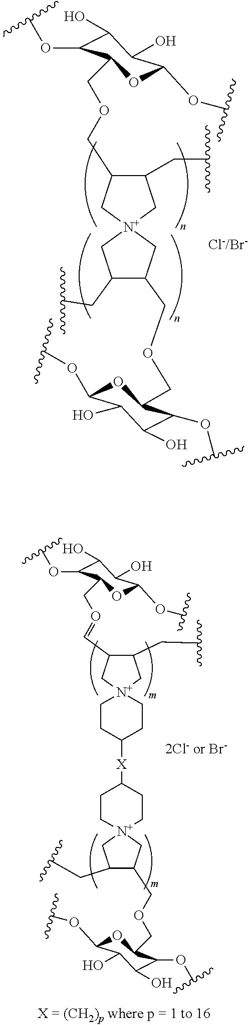

wherein m is in a range from about 200 to about 500. Again, such structural depictions are simplified and not intended to be limiting with respect to the actual product structure as crosslinking is not illustrated.

The cationized cellulosic fiber or fabric of the disclosure in some embodiments exhibit one or more favorable properties relative to non-cationized materials, or to those prepared by the CHPTAC method. These properties include, but are not limited to, improved properties with respect to dyeing and/or improved color or color retention of the dyed material, antimicrobial properties, and wrinkle resistance, each relative to a reference material not prepared according to the disclosed method.

In some embodiment, the cationized cellulosic fiber or fabric of the present disclosure exhibits an increased number of dye sites in the fiber. In some embodiment, the cationized cellulosic fiber or fabric of the present disclosure exhibits an enhanced percent exhaustion when dyed as described herein below. In some embodiment, the cationized cellulosic fiber or fabric of the present disclosure, when dyed using exhaustion, foam, cold-pad batch, or pad-steam-dry methods, produces a dyed cationized cellulosic fiber or fabric having a darker shade than that for a reference cellulosic fiber or fabric which has not been cationized, or which has been cationized by the CHPTAC method. In some embodiment, the cationized cellulosic fiber or fabric of the present disclosure, is readily dyed using a recycled dye bath, and provides a resulting dyed material comparable to that prepared with a fresh dye bath. In some embodiment, the cationized cellulosic fiber or fabric of the present disclosure may be dyed in the absence of salts.

In some embodiments, the cationized cellulosic fiber or fabric, the dyed cationized cellulosic fiber or fabric, or both, has antimicrobial properties, meaning the fabric either does not support bacterial growth, actively suppresses bacterial growth, or reduces the number of viable bacteria present on the material after a period of time. This antimicrobial property may be toward Gram-positive bacteria, Gram-negative bacteria, or both. In some embodiments, the cationized cellulosic fiber or fabric provides a reduction of about 99.99% or more of a Gram-positive bacteria compared to a non-cationized cellulosic fiber or fabric control after 24 hours. In some embodiments, the cationized cellulosic fiber or fabric provides a reduction of about 99% or more of a Gram-negative bacteria compared to an undyed, non-cationized cellulosic fiber or fabric control after 24 hours.

It has been found according to the present disclosure that cellulosic fibers cationized with certain monomers or combinations of monomers and crosslinkers, exhibit desirable properties such as resistance to or freedom from wrinkles. In some embodiments, cellulosic fibers cationized with tetraallyl ammonium monomers such as TAAB, TAAC, TAMPB, or TAMPC exhibit resistance to or freedom from wrinkles. Without wishing to be bound by any particular theory, it is believed that these wrinkle resistance properties are a result of extensive crosslinking of cellulose chains.

### Dyeing Cationized Fibers

In another aspect is provided a method of dyeing cationized cellulosic fibers or fabric as disclosed herein. The method generally comprises contacting the cationized cellulosic fiber or fabric with a solution comprising a dye, such as a natural dye, a reactive dye, a direct dye, or an acid dye. The method may be applied to the cationized cellulosic fiber or fabric of the disclosure in any form. In some embodiments, the cationized cellulosic fiber or fabric is cationized cotton. In some embodiments, the cationized cotton is in the form of fibers or yam. In some embodiments, the cationized cotton is in the form of a fabric, such as a woven or knit cotton fabric.

The contacting may be performed using various techniques, including exhaustion dyeing, pad-steam-dry methods, cold-pad batch, and foam methods, using fresh or recycled dye baths. In some embodiments, the dyeing is performed by an exhaustion method at or close to room temperature. In some embodiments, the dyeing is performed by a cold-pad-batch method. In some embodiments, the dyeing is performed via a pad-steam method, with or without drying. In some embodiments, the dyeing is performed via a foam method (e.g., in a foam dyeing machine). In some embodiments, the cationized cellulosic fiber or fabric is contacted with a dye solution in a bath, such as by dipping the fiber or fabric in the bath or passing the fiber or fabric through the bath. This contacting may be performed once, or may be repeated serially any number of times.

In some embodiments, the cationized cotton is dyed without using any salts. In contrast, non-cationized cotton requires the presence of salts, including alkaline salts, to promote dye exhaustion and offset the zeta potential generated on the surface of cellulose, resulting in increased dye uptake. In the presence of alkaline salts such sodium carbonate, a covalent bond is formed between the dye and primary hydroxyl groups of cellulose. Types of salts typically utilized in fabric dyeing include neutral or slightly acidic salts (i.e., salts which, when dissolved in water, produce a solution having a pH of about 7 (neutral) or from about 6.9 to about 5 (slightly acidic)), including alkali metal halides, alkali metal sulfates, transition metal or other metal sulfates; and alkaline salts, including but not limited to alkali metal and alkaline earth metal hydroxides and carbonates. Alkaline salts, when dissolved in water, produce a solution having a pH above about 7.5, such as from about 8 to 14. Examples of salts typically utilized in fabric dyeing include sodium chloride, potassium chloride, zinc sulfate, copper sulfate, aluminum sulfate, sodium sulfate (Glauber's salt), ammonium halides (e.g., ammonium chloride), and sodium and potassium hydroxide, and sodium carbonate.

In some embodiments, the dye solution (i.e., the dye bath) is substantially or completely free of salts (e.g., neutral, acidic, and/or alkaline). By “substantially free” is meant that no salts are intentionally added, and no salts are present beyond trace amounts, such as may be introduced as contaminants in one or more of the dye bath components. In some embodiments, the dye solution comprises less than about 1% by weight of any salts (or, specifically alkaline salts), such as about 0.1% or less, about 0.01% or less, about 0.001% or less, or even 0% by weight of any salts, based on the total weight of the dye solution.

In some embodiments, the dye solution (i.e., the dye bath) is substantially free of neutral or acidic salts, including but not limited to sodium chloride, potassium chloride, zinc sulfate, copper sulfate, aluminum sulfate, sodium sulfate, and ammonium chloride.

In some embodiments, the dye solution is substantially or completely free of alkaline salts, including but not limited to hydroxides and carbonates. The absence of any alkaline salt may be quantified by reference to a pH of the dye bath, which in alkali-free embodiments, is typically in a range from about 6.8 to about 7.4. In other words, the dye bath in alkali-free embodiments is essentially neutral. In contrast, when alkaline salts are utilized, the bath pH would be on the order of about 11.

In some embodiments, the dye solution is substantially or completely free of sodium sulfate, sodium carbonate, or both sodium sulfate and sodium chloride. In some embodiments, the dye solution is substantially or completely free of any acid, neutral, and alkaline salts.

Any suitable dye substance may be utilized, including reactive dyes, direct dyes, acid dyes, or natural dyes. In some embodiments, the dyeing is exhaustion dyeing. In some embodiments, the exhaustion dyeing is performed using a recycled dye bath. In some embodiments, the dyeing is performed via a pad-steam-dry method with a reactive dye. In some embodiments, the dyeing is performed via a pad-steam-dry method with an acid dye or a direct dye. In some embodiments, the dyeing is performed via foam dyeing with a reactive or direct dye.

In some embodiments, following the dyeing, the dye bath is clear. By “clear” is meant that the dye bath is transparent and colorless to the naked eye. This is indicative of complete uptake of the dye by the cationized fiber or fabric. The production of a clear dye bath is advantageous, as the bath can be recycled for further dyeing by adding fresh dye and still achieves a shade match with material dyed with a fresh bath which has not been recycled.

### Properties of Dyed Cationized Cellulosic Fibers and Fabrics

In another aspect is provided a dyed cellulosic fiber or fabric comprising a cationized cellulosic fiber or fabric as disclosed herein, and further comprising an ionically bound dye. The dyed materials of the present disclosure may, in some embodiments, exhibit one or more desirable properties, including but not limited to, depth of color, colorfastness, wrinkle resistance, (depending on the cationic monomer used), and antimicrobial activity. In some embodiments, these properties are present when the cationized cellulosic fiber or fabric is dyed in the absence of salts, as described herein above. In some embodiments, the cationized cellulosic fiber or fabric is cationized cotton, rayon, viscose, linen, modal, or lyocell. In some embodiments, the cationized cellulosic fiber or fabric is cationized cotton. In some embodiments, the cationized cotton is in the form of fibers or yam. In some embodiments, the cationized cotton is in the form of a fabric, such as a woven cotton fabric.

In some embodiments, the dyed cationized cellulosic fiber or fabric (such as cotton) of the disclosure, when dyed using an exhaustion method, in the absence of salts, exhibits improved color yield and/or color fastness compared to a CHPTAC-treated cellulosic fiber or fabric (such as cotton) dyed in the presence of salts (i.e., conventional method). In particular, as described in the Examples hereinbelow, dyed DADMAC-cationized cotton of the disclosure was compared against dyed material prepared from cotton cationized using CHPTAC. Dyed DADMAC-cationized cotton of the disclosure was also compared against uncationized cotton dyed using the conventional method.

In some embodiments, cationized cellulosic fiber or fabric (such as cotton) of the disclosure, when dyed using a recycled dye bath (recycled four successive times) furnished similar color yield and colorfastness properties compared to the same cellulosic fiber or fabric (such as cotton) when dyed using a fresh dye bath.

In some embodiments, cationized cellulosic fiber or fabric (such as cotton) of the disclosure, when dyed using a pad-steam-dry method of dyeing with black dyes and zero salts (e.g., sodium sulfate and sodium carbonate), the color yield of cationized cellulosic fiber or fabric (such as cotton) of the present disclosure was higher than CHPTAC-treated cellulosic fiber or fabric (such as cotton) dyed by the same method.

In some embodiments, the color yield of cationized cellulosic fiber or fabric (such as cotton) of the disclosure, when dyed with other dyes using zero salts (e.g., in the absence of sodium sulfate and sodium carbonate), was also higher than that of untreated cellulosic fiber or fabric (such as cotton) dyed using a conventional reactive dyeing method in the presence of salts (e.g., in the presence of sodium sulfate and sodium carbonate).

In some embodiments, dyed cationized cellulosic fiber or fabric (such as cotton) of the present disclosure showed comparable colorfastness toward dry crocking, laundering, and light as compared to dyed CHPTAC-treated cellulosic fiber or fabric (such as cotton) and to dyed untreated cellulosic fiber or fabric (such as cotton) for both exhaustion and pad-steam-dry dyeing methods.

In some embodiments, the color yield and colorfastness properties of dyed cationized cellulosic fiber or fabric (such as cotton) of the present disclosure, dyed with gold and cyan using foam dyeing using zero salts (e.g., in the absence of sodium sulfate and sodium carbonate), were very good to excellent.

In some embodiments, in the case of darker shades, the colorfastness to laundering and wet crocking, respectively, of dyed cationized cellulosic fiber or fabric (such as cotton) of the present disclosure was very good to acceptable, even when a high concentration (e.g., 150 g/L) of black dye was used.

In some embodiments, when dyed using a dye bath recycled four successive times, dyed cationized cellulosic fiber or fabric (such as cotton) of the present disclosure still furnished similar color yield and colorfastness properties to dyed cationized cellulosic fiber or fabric (such as cotton) dyed with a fresh bath, whether dyed with or without alkaline salts (e.g., in the presence or absence of sodium carbonate).

In some embodiments, the dyed cationized cellulosic fiber or fabric (such as cotton) of the present disclosure has antibacterial properties. In some embodiments, the dyed cationized cotton has activity against Gram-positive bacteria, Gram-negative bacteria, or both. In some embodiments, the dyed, cationized cellulosic fiber or fabric provides a reduction of about 99.99% or more of a Gram-positive bacteria compared to an undyed, non-cationized cellulosic fiber or fabric control after 24 hours. In some embodiments, the dyed, cationized cellulosic fiber or fabric provides a reduction of about 99% or more of a Gram-negative bacteria compared to an undyed, non-cationized cellulosic fiber or fabric control after 24 hours. Antimicrobial properties may be evaluated according to known methods, such as those described herein in Example 7.

### EXEMPLIFICATION

The present invention may be further illustrated by the following non-limiting examples describing the methods.

### Example 1. Graft Polymerization of DADMAC into Cotton Twill Fabrics

Cotton fabrics (Size=63 m×1.5 m, Weight≈24.4 kg) were padded (1 dip & 1 nip) with an aqueous solution containing 10 to 25 wt. % diallyldimethylammonium chloride (DADMAC) solution (65 wt. % in H₂O), 0.5-3.2% potassium persulfate (KPS) on the basis of weight of bath (owb), and 1 to 2% owb N,N′-methylenebisacrylamide (MBA). Cotton fabrics were padded at 20 bar and 1 m/min using a Greenville padding machine to obtain about 74% wet pick up. Wet cotton fabrics were dried at 100° C. for 7 min and cured at a temperature between 11° and 180° C. for 1.5 min using a tenter frame oven (Marshall and Williams Company). Cured cotton fabrics were washed three times with water at 65° C. using a Jet machine (Thies GmbH & Co.) to remove ungrafted poly-DADMAC. The washed cotton fabrics were padded using a Greenville padding machine at 20 bar and 1 m/min to extract excess water and dried at 100° C. for 7 min using a tenter frame oven to obtain 2-6% dry add-on.

### Example 2. Exhaustion Dyeing

In the exhaustion dyeing method, untreated cotton (reference), 3-chloro-2-hydroxypropyltrimethylammonium chloride (CHPTAC)-treated cotton (reference) and cotton cationized by graft polymerization of DADMAC (inventive; prepared according to Example 1) were dyed with 4% on weight of fiber (owf) REMAZOL® Deep Black GWF, 5.5% owf Everzol Black B H/C, 5.5% REMAZOL® Brilliant Yellow 3GL and 5.5% Levafix Yellow CA Gran at a 10:1 liquor ratio in a Datacolor AHIBA NUANCE dye machine, model 1000 (Salvis AG, Switzerland). Untreated cotton fabrics (Size≈0.36 m×0.17 m, Weight≈17 g) were put in a beaker containing water, 65 g/L of Na₂SO₄ (60 g/L of Na₂SO₄ for REMAZOL® Deep Black GWF) and 0.5% owb Pomolev NHM at room temperature (RT). The beaker was sealed with a lid and the temperature of the machine was raised to 30° C. and the beaker was revolved for 10 min so that the cotton fabrics absorbed enough water. The dye solution was added to the beaker and the beaker was revolved for another 10 min at 30° C. The temperature of the machine was raised at 2.5° C. per min to 60° C. Dyeing was continued for 40 min and 18 g/L of Na₂CO₃ (alkaline salt) was added. The dyeing cycle was completed after an additional 40 min.

CHPTAC-treated cotton and cotton cationized by graft polymerization of DADMAC (Size≈0.36 m×0.17 m, Weight≈17 g) were dyed with or without using Na₂CO₃. Cationized cotton fabrics were put in a beaker containing water and 0.5% owb Pomolev NHM at RT. Lid of the beaker was sealed, the temperature of the machine was raised to 30° C. and the beaker was revolved for 10 min. Dye solution was added to the beaker. The beaker was revolved for another 10 min at 30° C. Then the temperature of the machine was raised at 2.5° C. per min to 60° C. Dyeing was completed after 40 min when no Na₂CO₃ was used. Alternatively, dyeing was performed in a jet dyeing machine, adding the dye solution in 8 increments, and the dyeing was completed after 20 minutes. On the other hand, when the cationized cotton fabrics were dyed with Na₂CO₃, the Na₂CO₃ was added after the machine temperature reached 60° C. The dyeing cycle was completed after 40 min.

The dyed fabrics were rinsed in cold water followed by washing in a bath containing 0.5 g/L of nonionic detergent in boiling water for 5 min. The washed cotton fabrics were centrifuged to extract the excess water and dried in an oven.

### Color Yield

Color yield of the dyed fabrics were determined using a Color i7 (x-rite PANTONE). All dyed fabrics were folded into four-layer (for infinite thickness), and color yield was measured at 4 sections of the fabric and the average value was recorded. The color yield is a ratio of the absorption coefficient to the scattering coefficient, determined calculated from the Kubelka-Munk equation:

$$\frac{K}{S} = \frac{{( 1 - {R}_{∞} )}^{2}}{2 {R}_{∞}} ,$$

where K is the absorption coefficient, S is the scattering coefficient, and R_{∞} is the reflectance of the dyed fabrics for infinite thickness. Since black dyes are combination of dyes, total K/S was measured.

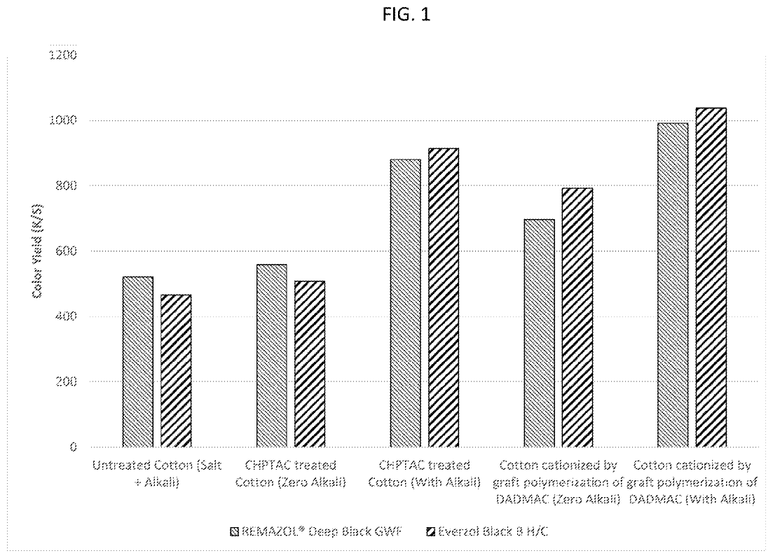

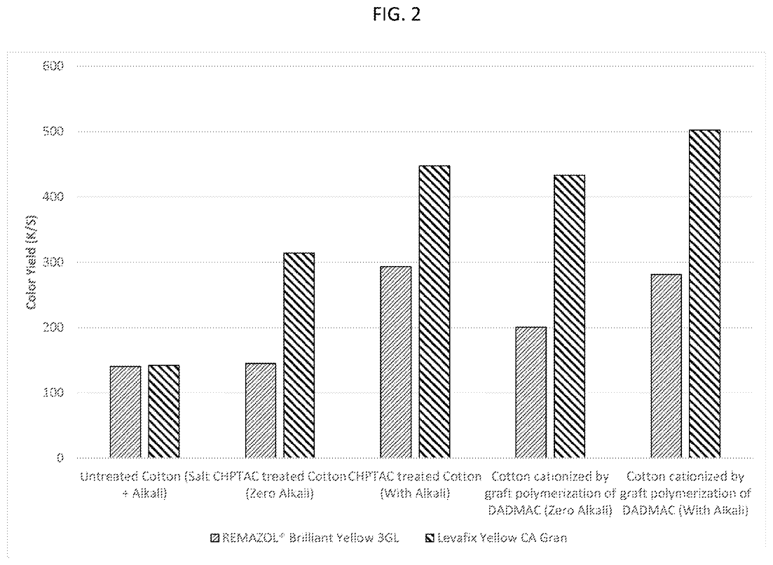

FIG. 1 and FIG. 2 show the color yield of untreated cotton, CHPTAC-treated cotton, and cotton cationized by graft polymerization of DADMAC when dyed with 4% owf REMAZOL® Deep Black GWF, 5.5% owf Everzol Black B H/C, 5.5% owf REMAZOL® Brilliant Yellow 3GL and 5.5% owf Levafix Yellow CA Gran at 10:1 liquor ratio.

As shown in FIG. 1, the color yield of cotton cationized by graft polymerization of DADMAC dyed using no Na₂SO₄ or Na₂CO₃ (zero salts) was higher than CHPTAC-treated cotton dyed using zero salts and untreated cotton dyed using Na₂SO₄ and Na₂CO₃. Again, when Na₂CO₃ was used, the color yield of dyed cotton cationized by graft polymerization of DADMAC was higher than that of dyed CHPTAC-treated cotton.

As shown in FIG. 2, the color yield of cotton cationized by graft polymerization of DADMAC dyed using no Na₂SO₄ or Na₂CO₃ was higher than CHPTAC-treated cotton dyed using zero salts and untreated cotton dyed using Na₂SO₄ and Na₂CO₃. Again, when Na₂CO₃ was used, the color yield of cotton cationized by graft polymerization of DADMAC was significantly higher than CHPTAC-treated cotton when dyed with Levafix Yellow CA Gran, 502 versus 447, respectively. In case of REMAZAOL® Brilliant Yellow 3GL, the color yield of cotton cationized by graft polymerization of DADMAC using no Na₂SO₄ or Na₂CO₃ was also higher than CHPTAC-treated cotton; however, when Na₂CO₃ was used, the color yield was comparable (293 for CHPTAC vs 280 for DADMAC).

### Colorfastness Properties

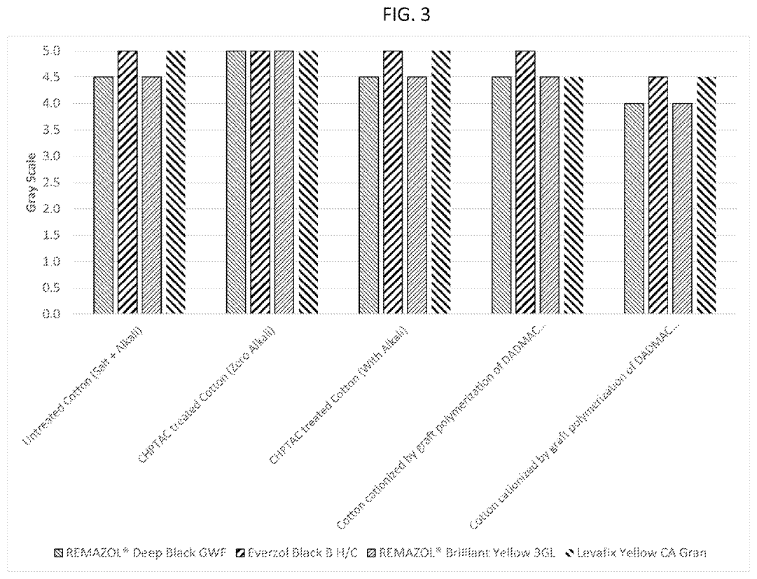

Colorfastness to crocking of all dyed fabrics was measured using an American Association of Textile Chemists and Colorists (AATCC) crockmeter (Model: CM-5, Atlas Electric Devices Co.) and following AATCC test method 8-2016, Colorfastness to Crocking: Crockmeter Method. Staining of the AATCC crock squares was evaluated in a light booth (GretagMacbeth, Model: JUDGE II) using the AATCC grayscale for evaluating staining. FIG. 3 shows the staining results of dyed untreated cotton, dyed CHPTAC-treated cotton and dyed cotton cationized by graft polymerization of DADMAC in grayscale for dry crocking.

As shown in FIG. 3, CHPTAC-treated cotton dyed using no Na₂SO₄ or Na₂CO₃ was slightly higher than cotton cationized with DADMAC in colorfastness to dry crocking. Colorfastness to dry crocking of cotton cationized by graft polymerization of DADMAC dyed using zero Na₂CO₃ was comparable to CHPTAC-treated cotton dyed using zero Na₂CO₃ and untreated cotton dyed using Na₂SO₄ and Na₂CO₃. On the other hand, when Na₂CO₃ was used, the colorfastness to dry crocking of dyed cotton cationized by graft polymerization of DADMAC was comparable to CHPTAC-treated cotton dyed using alkali and untreated cotton dyed using Na₂SO₄ and Na₂CO₃.

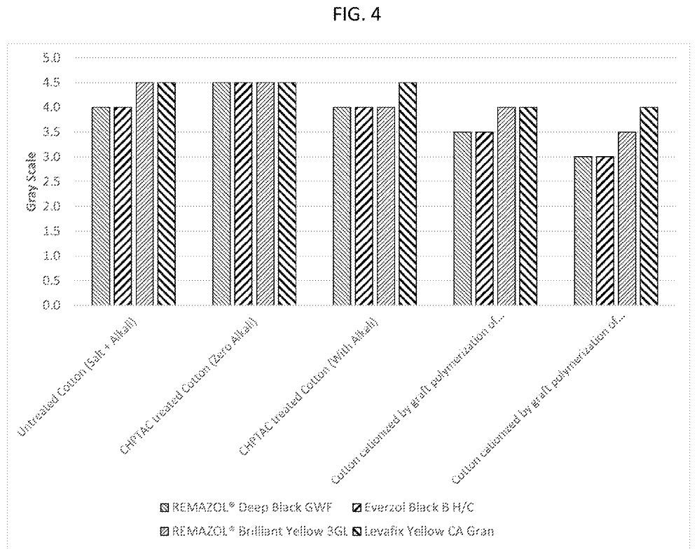

FIG. 4 shows the staining results of dyed untreated cotton, dyed CHPTAC-treated cotton and dyed cotton cationized by graft polymerization of DADMAC in grayscale for wet crocking. As shown in FIG. 4, CHPTAC-treated cotton dyed using no Na₂SO₄ or Na₂CO₃ was slightly higher than cotton cationized with DADMAC using no Na₂SO₄ or Na₂CO₃ in colorfastness to wet crocking. Colorfastness to wet crocking of cotton cationized by graft polymerization of DADMAC dyed using zero Na₂CO₃ was comparable to untreated cotton dyed using Na₂SO₄ and Na₂CO₃ but lower than CHPTAC-treated cotton dyed using zero Na₂CO₃. Again, when Na₂CO₃ was used colorfastness to wet crocking of dyed cotton cationized by graft polymerization of DADMAC was lower than CHPTAC-treated cotton dyed using Na₂CO₃ and untreated cotton dyed using Na₂SO₄ and Na₂CO₃.

Colorfastness to laundering of all dyed fabrics was examined using Atlas LEF Launder-Ometer (Atlas Electric Devices Co.) and following AATCC test method 61-2013 (Test Condition: 2A), Colorfastness to Laundering: Accelerated. Samples exposed to this test show color change comparable to that produced by five home machine launderings at medium or warm setting at 38±3° C. Color change of the cotton strip of the multifiber strips was evaluated in a light booth (GretagMacbeth, Model: JUDGE II) using the AATCC grayscale for evaluating staining.

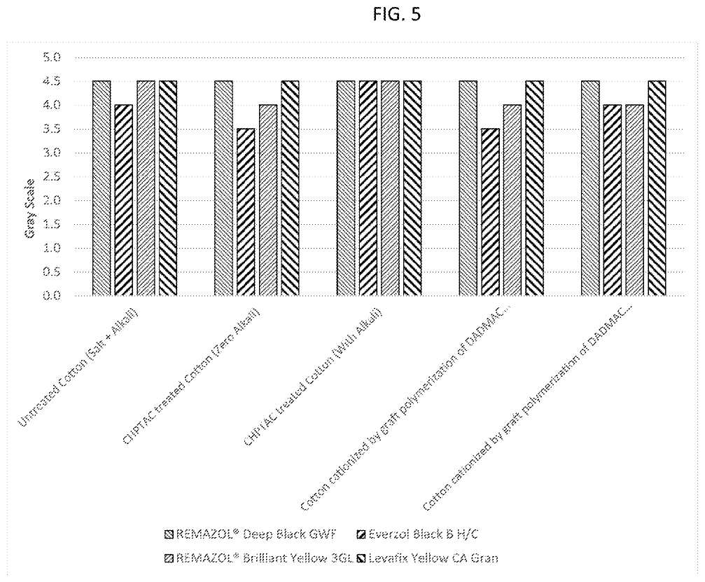

FIG. 5 shows the staining results of dyed untreated cotton, dyed CHPTAC-treated cotton and dyed cotton cationized by graft polymerization of DADMAC in grayscale for laundering. As shown in FIG. 5, colorfastness to laundering of cotton cationized by graft polymerization of DADMAC dyed using zero Na₂CO₃ was comparable to CHPTAC-treated cotton dyed using zero Na₂CO₃ and untreated cotton dyed using Na₂SO₄ and Na₂CO₃. Again, colorfastness to laundering of cotton cationized by graft polymerization of DADMAC dyed using Na₂CO₃ was comparable to CHPTAC-treated cotton dyed using Na₂CO₃ and untreated cotton dyed using Na₂SO₄ and Na₂CO₃.

Colorfastness to light of all dyed fabrics was studied using Atlas Ci3000+ Xenon Fade-Ometer (Atlas Electric Devices Co.) and following AATCC test method 16.1-2014, Colorfastness to Light: Outdoor. Test conditions were set to simulate conditions in Miami, Florida (hereinafter “MIAMI” conditions) where total annual radiation is 2800 kj/m² @ 340 nm. For the test, 0.55 W/m² irradiation was used at 340 nm, rack panel and chamber temperatures were set at 63° C. and 43° C., respectively and relative humidity was set at 50%. Samples exposed to this test show color change comparable to that produced by 3 times Miami exposure. All dyed fabric samples were exposed to this test for 20 hours (equivalent to 5 days) and 40 hours (equivalent to 10 days). Color change of the samples was evaluated in a light booth (GretagMacbeth, Model: JUDGE II) using the AATCC grayscale for evaluating change in color.

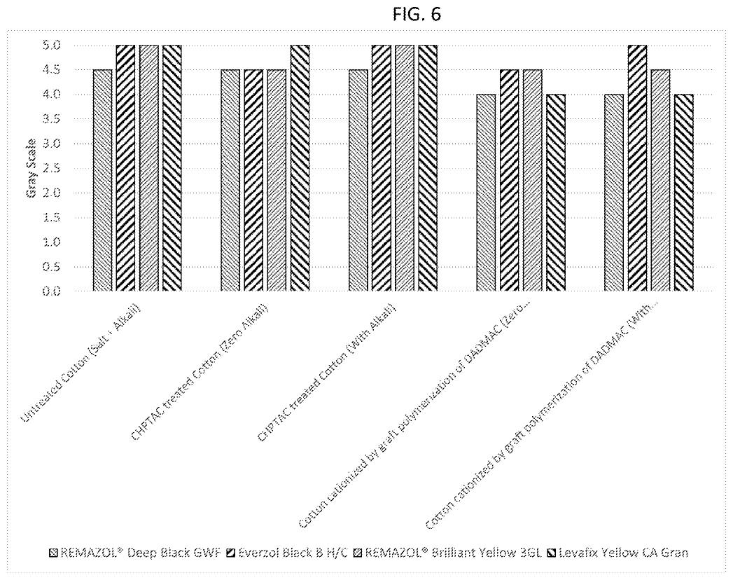

FIG. 6 shows the color change results for lightfastness of dyed untreated cotton, dyed CHPTAC-treated cotton and dyed cotton cationized by graft polymerization of DADMAC in grayscale which were exposed to MIAMI conditions for 20 hours. As shown in FIG. 6, after 20 hours exposure to MIAMI conditions colorfastness to light of cotton cationized by graft polymerization of DADMAC was comparable to CHPTAC-treated cotton and untreated cotton when dyed with 4% owf REMAZOL® Deep Black GWF, 5.5% owf Everzol Black B H/C and 5.5% owf REMAZOL® Brilliant Yellow 3GL. On the other hand, after 20 hours exposure to MIAMI conditions colorfastness to light of cotton cationized by graft polymerization of DADMAC was lower than CHPTAC-treated cotton and untreated cotton when dyed with 5.5% owf Levafix Yellow CA Gran.

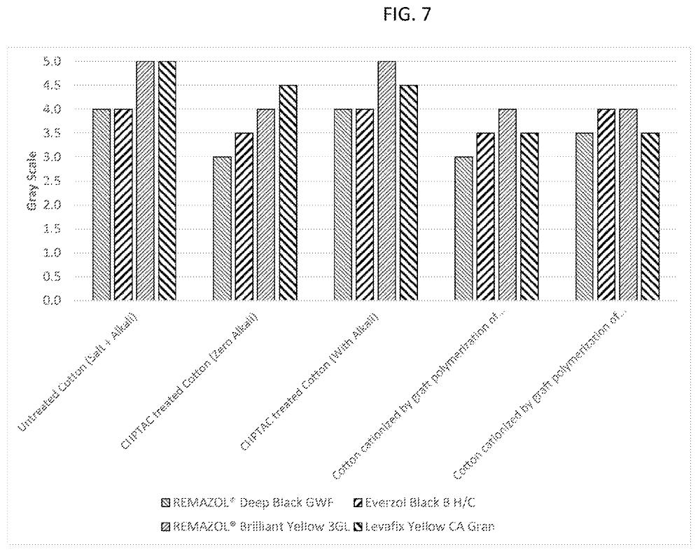

FIG. 7 shows the color change results for lightfastness of dyed untreated cotton, dyed CHPTAC-treated cotton and dyed cotton cationized by graft polymerization of DADMAC in grayscale which were exposed to MIAMI conditions for 40 hours. As shown in FIG. 7, after 40 hours exposure to MIAMI conditions, colorfastness to light of cotton cationized by graft polymerization of DADMAC dyed with zero Na₂CO₃ was comparable to CHPTAC-treated cotton dyed with zero Na₂CO₃ for REMAZOL® Deep Black GWF, Everzol Black B H/C and REMAZOL® Brilliant Yellow 3GL. On the other hand, colorfastness to light of cotton cationized by graft polymerization of DADMAC dyed with zero Na₂CO₃ was lower than CHPTAC-treated cotton dyed with zero Na₂CO₃ for Levafix Yellow CA Gran.

Again, after 40 hours exposure to MIAMI conditions colorfastness to light of cotton cationized by graft polymerization of DADMAC dyed with Na₂CO₃ was comparable to CHPTAC-treated cotton dyed with Na₂CO₃ and untreated cotton dyed with Na₂SO₄ and Na₂CO₃ for REMAZOL® Deep Black GWF and Everzol Black B H/C. Alternatively, dyeing was performed in a jet dyeing machine, adding the dye solution in 8 increments, and the dyeing was completed after 20 minutes. On the for other hand, colorfastness to light of cotton cationized by graft polymerization of DADMAC dyed with Na₂CO₃ was slightly lower than CHPTAC-treated cotton dyed with Na₂CO₃ and untreated cotton dyed with Na₂SO₄ and Na₂CO₃ for REMAZOL® Brilliant Yellow 3GL and Levafix Yellow CA Gran.

### Example 3. Recycled Dye Bath

Cotton cationized by graft polymerization of DADMAC (inventive; prepared according to Example 1) was dyed with 4% owf REMAZOL® Deep Black GWF at 10:1 liquor ratio in a Datacolor AHIBA NUANCE dye machine, model 1000 (Salvis AG, Switzerland). Cationized cotton fabrics were dyed with or without using Na₂CO₃. Cationized cotton fabrics (Size≈0.36 m×0.17 m, Weight≈17 g) were put in a beaker containing water and 0.5% owb Pomolev NHM at room temperature (RT). The lid of the beaker was sealed; the temperature of the machine was raised to 30° C. and the beaker was revolved for 10 min. Dye solution was added to the beaker. The beaker was revolved for another 10 min at 30° C. Then the temperature of the machine was raised at 2.5° C. per min to 60° C. Dyeing was completed after 40 min when no Na₂CO₃ was used. On the other hand, when the cationized cotton fabrics were dyed with Na₂CO₃, 18 g/L Na₂CO₃ was added after machine temperature reached to 60° C. The dyeing cycle was completed after 40 min in this case also. After completion of the dyeing, the dye bath was saved and used to dye the next set of cationized cotton in place of fresh water. Cationized cotton fabrics were dyed 4 times using the recycled dye bath with or without using Na₂CO₃.

Dyed fabrics were rinsed in cold water followed by washing in a bath containing 0.5 g/L of nonionic detergent in boiling water for 5 min. Washed cotton fabrics were centrifuged to extract the excess water and dried in an oven.

### Color Yield

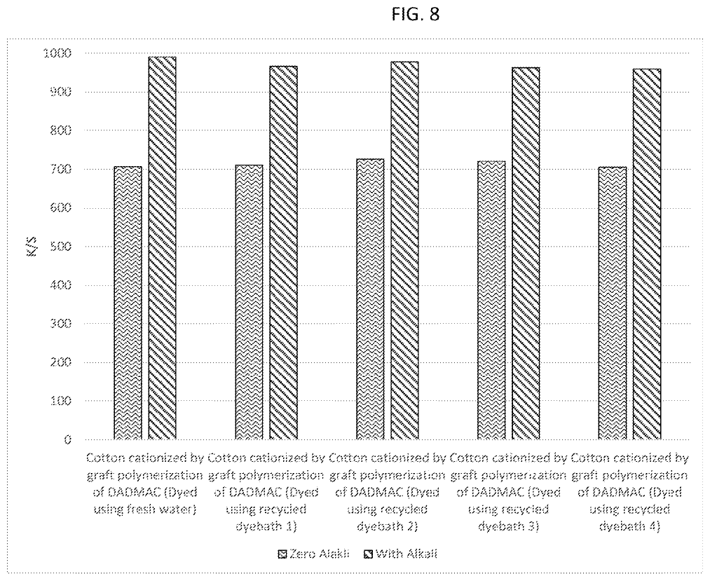

The color yield of cotton cationized by graft polymerization of DADMAC dyed using freshwater was compared to cotton cationized by graft polymerization of DADMAC dyed using recycled dye bath. As shown in FIG. 8, the color yield of cotton cationized by graft polymerization of DADMAC dyed using zero Na₂CO₃ was comparable and had no color difference (DE_{CMC}<1), whether dyed with fresh water or recycled dye bath. Similarly, the color yield of cotton cationized by graft polymerization of DADMAC dyed using Na₂CO₃ was also comparable and had no color difference (DE_{CMC}<1), whether dyed with fresh water or recycled dye bath.

### Colorfastness Properties

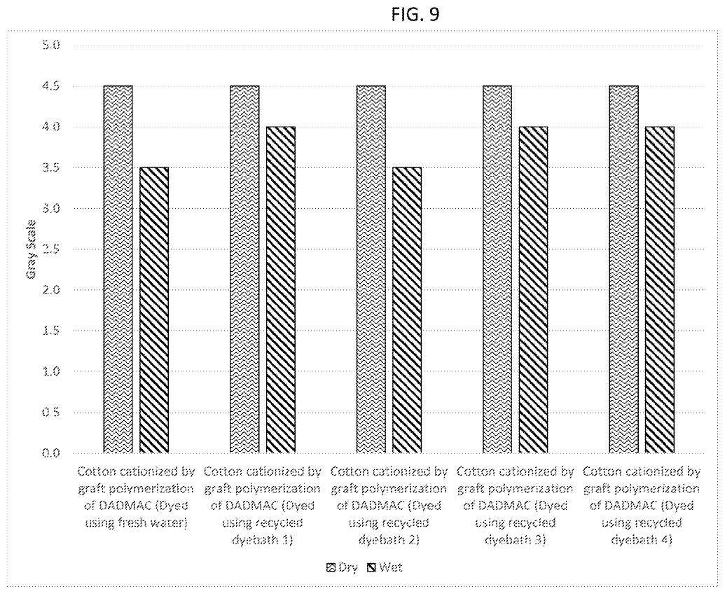

Colorfastness to crocking of cotton cationized by graft polymerization of DADMAC dyed using fresh water was compared to cotton cationized by graft polymerization of DADMAC dyed using recycled dye bath. FIG. 9 shows the staining results of cotton cationized by graft polymerization of DADMAC dyed using zero Na₂CO₃ in grayscale.

As shown in FIG. 9, when no Na₂CO₃ was used, colorfastness to dry crocking of cotton cationized by graft polymerization of DADMAC dyed using fresh water was about the same as the cotton cationized by graft polymerization of DADMAC dyed using a recycled dye bath. Similarly, colorfastness to wet crocking of cotton cationized by graft polymerization of DADMAC dyed using fresh water was comparable to cotton cationized by graft polymerization of DADMAC dyed using a recycled dye bath.

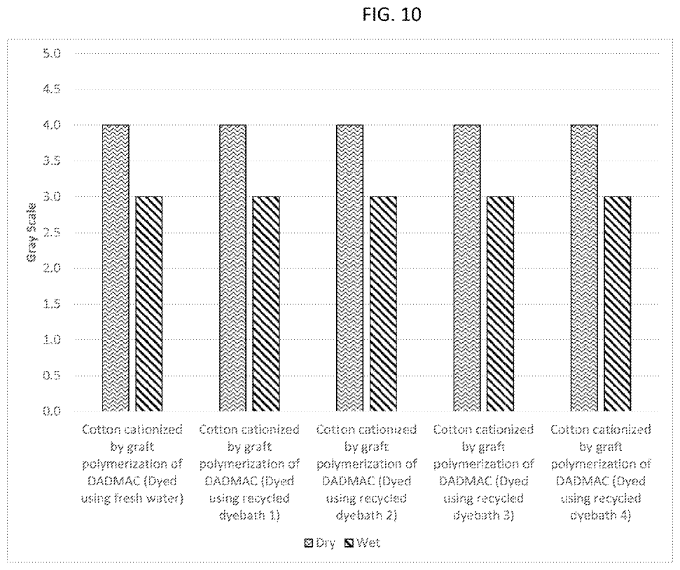

FIG. 10 shows the staining results of cotton cationized by graft polymerization of DADMAC dyed using Na₂CO₃ in grayscale. As shown in FIG. 10, when Na₂CO₃ was used, the colorfastness to dry crocking of cotton cationized by graft polymerization of DADMAC dyed using fresh water was about the same as cotton cationized by graft polymerization of DADMAC dyed using a recycled dye bath. Similarly, colorfastness to wet crocking of cotton cationized by graft polymerization of DADMAC dyed using fresh water was also about the same as cotton cationized by graft polymerization of DADMAC dyed using a recycled dye bath.

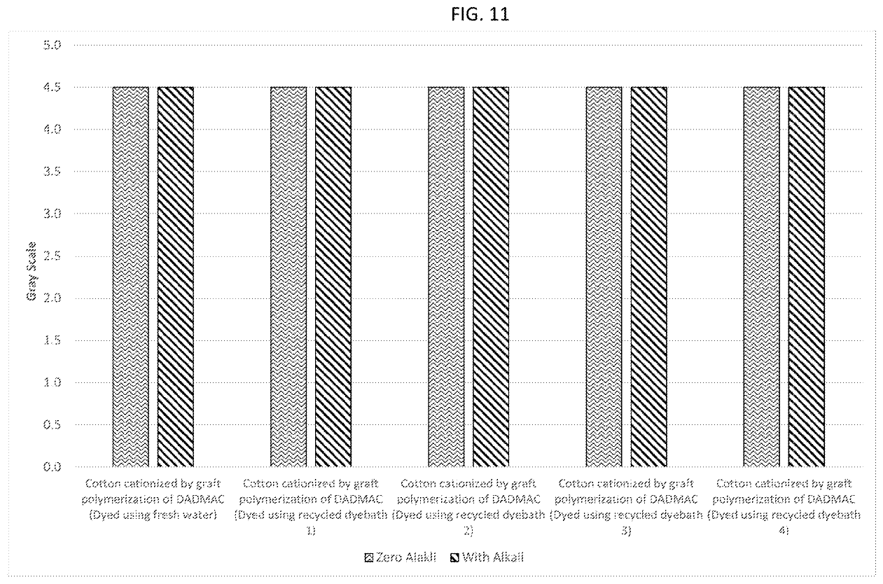

Colorfastness to laundering of cotton cationized by graft polymerization of DADMAC dyed using fresh water was compared to cotton cationized by graft polymerization of DADMAC dyed using a recycled dye bath. FIG. 11 shows the staining results of dyed cotton cationized by graft polymerization of DADMAC in grayscale.

As shown in FIG. 11, colorfastness to laundering of cotton cationized by graft polymerization of DADMAC dyed using fresh water was about the same as the cotton cationized by graft polymerization of DADMAC dyed using a recycled dye bath whether dyed with Na₂CO₃ or zero Na₂CO₃.

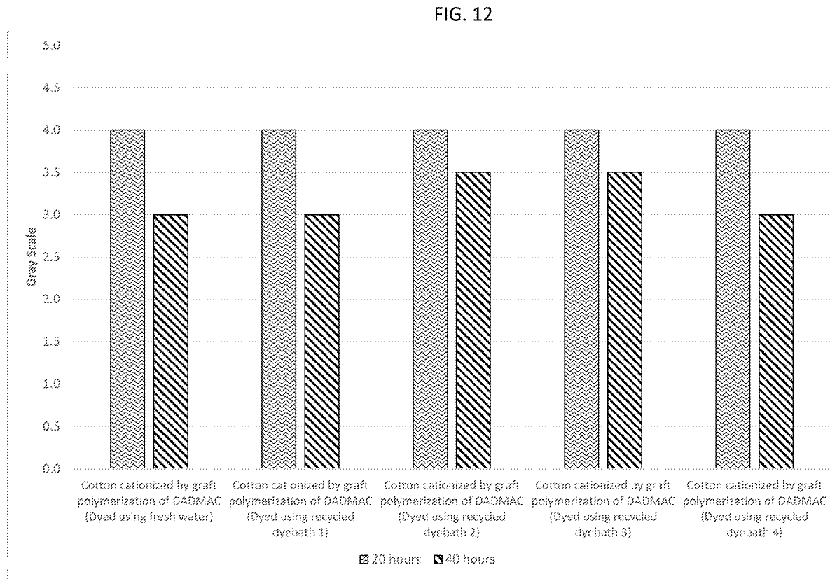

Colorfastness to light of cotton cationized by graft polymerization of DADMAC dyed using fresh water was compared to cotton cationized by graft polymerization of DADMAC dyed using recycled dye bath. FIG. 12 shows the color change results of cotton cationized by graft polymerization of DADMAC dyed using zero Na₂CO₃ in grayscale which were exposed to Miami conditions.

As shown in FIG. 12, when no Na₂CO₃ was used, colorfastness to light of cotton cationized by graft polymerization of DADMAC dyed using fresh water was about the same as the cotton cationized by graft polymerization of DADMAC dyed using recycled dye bath after 20 hours exposure to MIAMI conditions. Similarly, colorfastness to light of cotton cationized by graft polymerization of DADMAC dyed using fresh water was comparable to cotton cationized by graft polymerization of DADMAC dyed using a recycled dye bath after 40 hours exposure to MIAMI conditions.

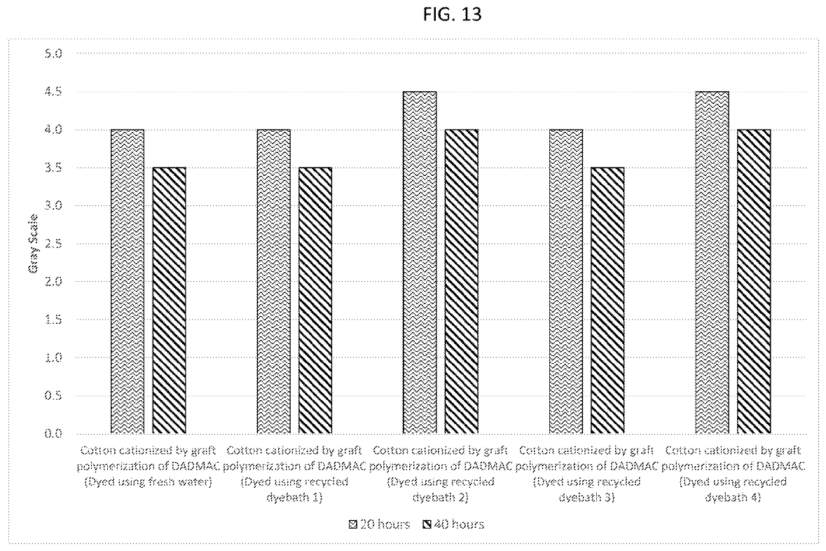

FIG. 13 shows the color change results of cotton cationized by graft polymerization of DADMAC dyed using Na₂CO₃ in grayscale which were exposed to MIAMI conditions. As shown in FIG. 13, when Na₂CO₃ was used, colorfastness to light of cotton cationized by graft polymerization of DADMAC dyed using fresh water was comparable to cotton cationized by graft polymerization of DADMAC dyed using a recycled dye bath after 20 hours exposure to MIAMI conditions. Similarly, colorfastness to light of cotton cationized by graft polymerization of DADMAC dyed using fresh water was also comparable to cotton cationized by graft polymerization of DADMAC dyed using a recycled dye bath after 40 hours exposure to MIAMI conditions.

### Example 4. Pad-Steam-Dry Dyeing with Reactive Dyes

In the Pad-Steam-Dry method, untreated cotton (reference), CHPTAC-treated cotton (reference), and cotton cationized by graft polymerization of DADMAC (inventive; prepared according to Example 1) were dyed with reactive dyes, namely REMAZOL® Deep Black GWF, Everzol Black B H/C, REMAZOL® Brilliant Yellow 3GL and Levafix Yellow CA Gran. Untreated cotton fabrics were cut into rectangular pieces (Size≈0.43 m×0.43 m, Weight≈32 g) and padded with dye solutions containing 120 g/L of dye, 150 g/L of Na₂SO₄, 30 g/L of Na₂CO₃ and 4% Leveler XCP 2. To ensure uniform ultra-deep dyeing, cotton fabrics were padded at 1.5 bar and 1 m/min using a HVF padding machine to obtain about 70% wet pick up. Padded cotton fabrics were steamed for 1.5 min using a DHE oven (Werner Mathis AG) and dried at 160° C. for 2 min using a LTF oven (Werner Mathis AG) to complete the dyeing process.

Cationized cotton fabrics (CHPTAC-treated cotton and cotton cationized by graft polymerization of DADMAC) were also cut into rectangular pieces (Size≈0.43 m×0.43 m, Weight≈32 g) and dyed with and without using Na₂CO₃. When Na₂CO₃ was not used, the cationized cotton fabrics were padded with dye solutions containing 120 g/L of dye and 4% Leveler XCP 2. When Na₂CO₃ was used, the cationized cotton fabrics were padded with dye solutions containing 120 g/L of dye, 30 g/L of Na₂CO₃ and 4% Leveler XCP 2.

Dyed fabrics were rinsed in cold water followed by washing in a bath containing 0.5 g/L of nonionic detergent (Apollo Scour) in boiling water for 5 min. Washed cotton fabrics were centrifuged to extract the excess water and dried in an oven.

### Color Yield

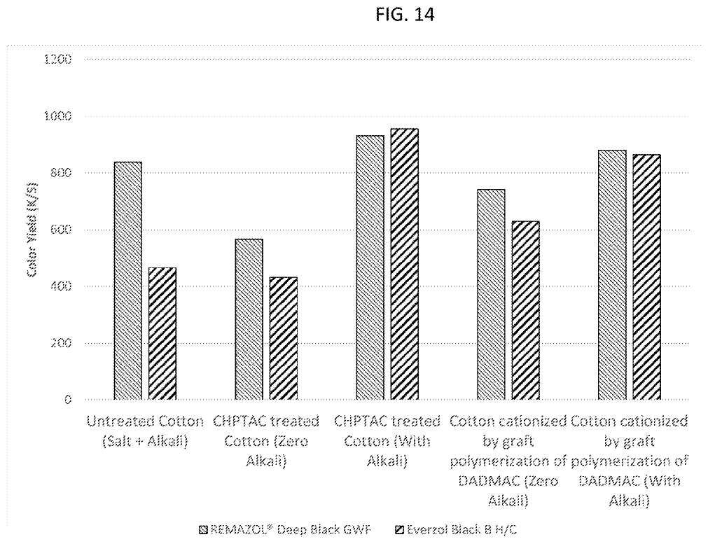

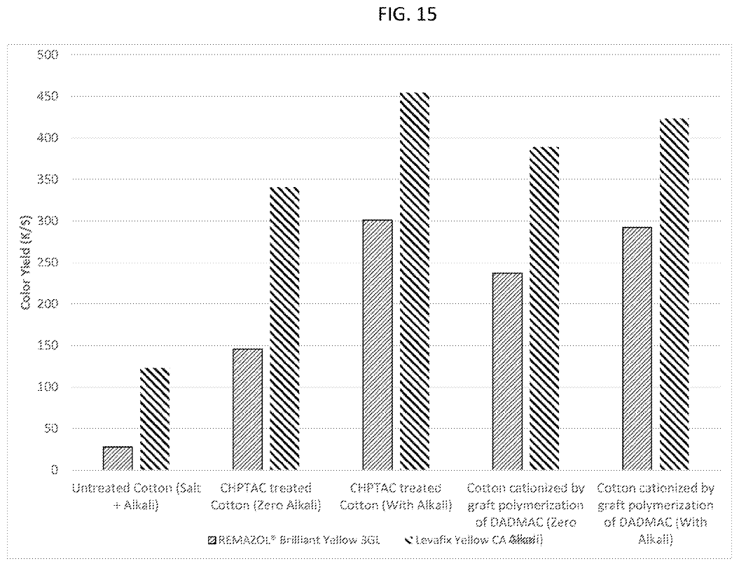

FIG. 14 and FIG. 15 show the color yield of untreated cotton, CHPTAC-treated cotton and cotton cationized by graft polymerization of DADMAC when dyed with REMAZOL® Deep Black GWF, Everzol Black B H/C, REMAZOL® Brilliant Yellow 3GL and Levafix Yellow CA Gran using the Pad-Steam-Dry method.

As shown in FIG. 14, the color yield of cotton cationized by graft polymerization of DADMAC dyed using zero Na₂CO₃ was higher than CHPTAC-treated cotton dyed using zero Na₂CO₃. On the other hand, when Na₂CO₃ was used, the color yield of dyed cotton cationized by graft polymerization of DADMAC was higher than untreated cotton dyed using Na₂SO₄ and Na₂CO₃, but lower than dyed CHPTAC-treated cotton.

As shown in FIG. 15, the color yield of cotton cationized by graft polymerization of DADMAC dyed using zero Na₂CO₃ was higher than CHPTAC-treated cotton dyed using zero Na₂CO₃. On the other hand, when Na₂CO₃ was used, the color yield of dyed cotton cationized by graft polymerization of DADMAC was higher than untreated cotton dyed using Na₂SO₄ and Na₂CO₃, but lower than dyed CHPTAC-treated cotton.

### Colorfastness Properties

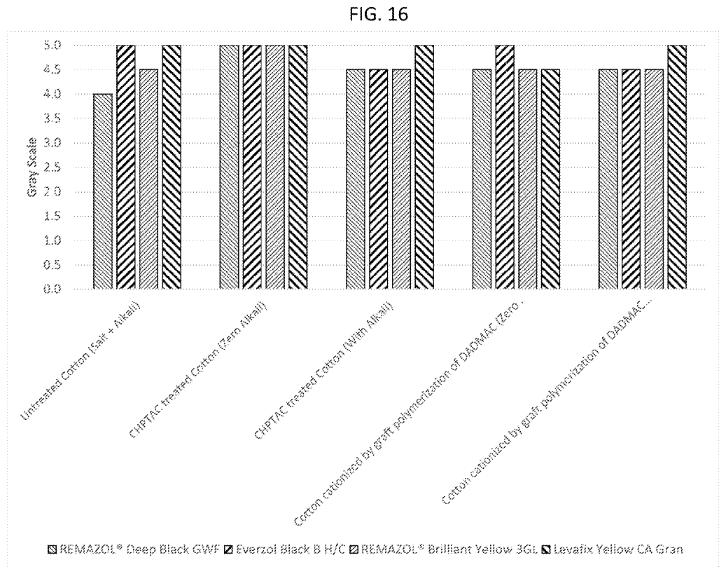

FIG. 16 shows the staining results of dyed untreated cotton, dyed CHPTAC-treated cotton and dyed cotton cationized by graft polymerization of DADMAC in grayscale for dry crocking. As shown in FIG. 16, CHPTAC-treated cotton dyed using zero Na₂CO₃ was slightly higher for some dyes than cotton cationized with DADMAC in colorfastness to dry crocking. On the other hand, when Na₂CO₃ was used, colorfastness to dry crocking of dyed cotton cationized by graft polymerization of DADMAC was comparable to CHPTAC-treated cotton dyed using Na₂CO₃ and untreated cotton dyed using Na₂SO₄ and Na₂CO₃.

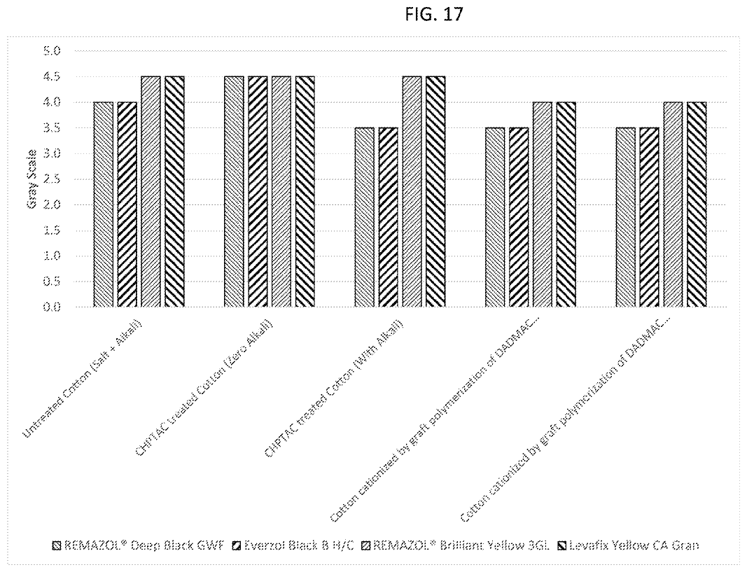

FIG. 17 shows the staining results of dyed untreated cotton, dyed CHPTAC-treated cotton and dyed cotton cationized by graft polymerization of DADMAC in grayscale for wet crocking. As shown in FIG. 17, CHPTAC-treated cotton dyed using zero Na₂CO₃ was slightly higher than cotton cationized with DADMAC in colorfastness to wet crocking. Colorfastness to wet crocking of cotton cationized by graft polymerization of DADMAC dyed using Na₂CO₃ was comparable to CHPTAC-treated cotton dyed using Na₂CO₃ and untreated cotton dyed using Na₂SO₄ and Na₂CO₃. On the other hand, colorfastness to wet crocking of cotton cationized by graft polymerization of DADMAC dyed using zero Na₂CO₃ was comparable to CHPTAC-treated cotton dyed using zero Na₂CO₃ for REMAZOL® Brilliant Yellow 3GL and Levafix Yellow CA Gran but lower for REMAZOL® Deep Black GWF and Everzol Black B H/C.

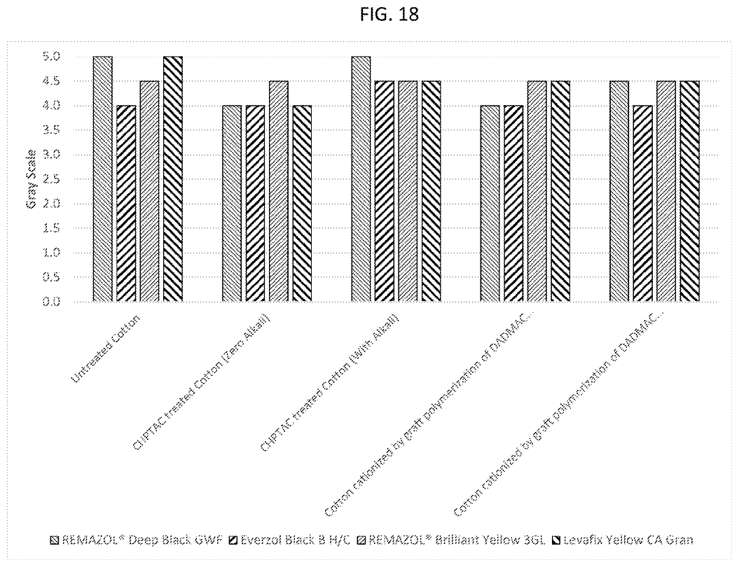

FIG. 18 shows the staining results of dyed untreated cotton, dyed CHPTAC-treated cotton and dyed cotton cationized by graft polymerization of DADMAC in grayscale for laundering. As shown in FIG. 18, the colorfastness to laundering of cotton cationized by graft polymerization of DADMAC dyed using zero Na₂CO₃ was comparable to CHPTAC-treated cotton dyed using zero Na₂CO₃. Again, colorfastness to laundering of cotton cationized by graft polymerization of DADMAC dyed using Na₂CO₃ was comparable to CHPTAC-treated cotton dyed using Na₂CO₃ and untreated cotton dyed using Na₂SO₄ and Na₂CO₃.

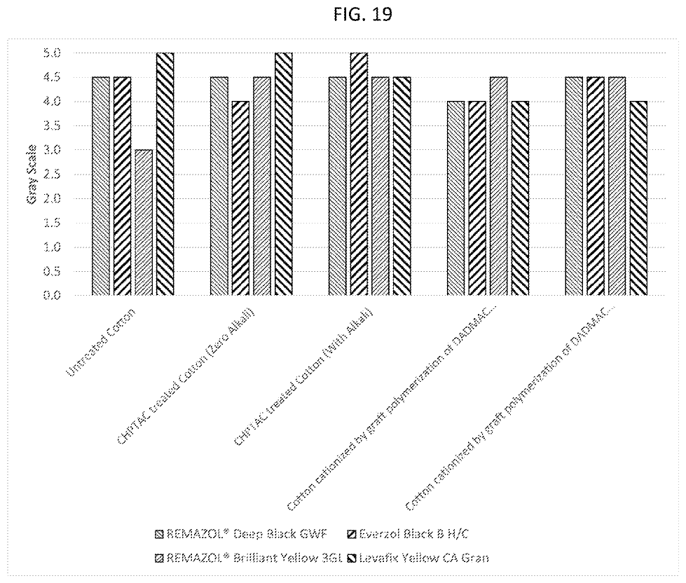

FIG. 19 shows the color change results for lightfastness of dyed untreated cotton, dyed CHPTAC-treated cotton and dyed cotton cationized by graft polymerization of DADMAC in grayscale which were exposed to MIAMI conditions for 20 hours. As shown in FIG. 19, after 20 hours exposure to MIAMI conditions, colorfastness to light of cotton cationized by graft polymerization of DADMAC dyed with Na₂CO₃ was comparable to CHPTAC-treated cotton dyed with Na₂CO₃ for REMAZOL® Deep Black GWF, Everzol Black B H/C, REMAZOL® Brilliant Yellow 3GL and Levafix Yellow CA Gran. Again, after 20 hours exposure to MIAMI conditions, colorfastness to light of cotton cationized by graft polymerization of DADMAC dyed with Na₂CO₃ was comparable to untreated cotton dyed with Na₂SO₄ and Na₂CO₃ for REMAZOL® Deep Black GWF and Everzol Black B H/C. On the other hand, after 20 hours exposure to MIAMI conditions colorfastness to light of cotton cationized by graft polymerization of DADMAC dyed with Na₂CO₃ was higher than untreated cotton dyed with Na₂SO₄ and Na₂CO₃ for REMAZOL® Deep Black GWF, but lower for Levafix Yellow CA Gran. Again, after 20 hours exposure to MIAMI conditions, colorfastness to light of cotton cationized by graft polymerization of DADMAC dyed with zero Na₂CO₃ was comparable to CHPTAC treated cotton dyed with zero Na₂CO₃ for REMAZOL® Deep Black GWF, Everzol Black B H/C and REMAZOL® Brilliant Yellow 3GL, but lower for Levafix Yellow CA Gran.

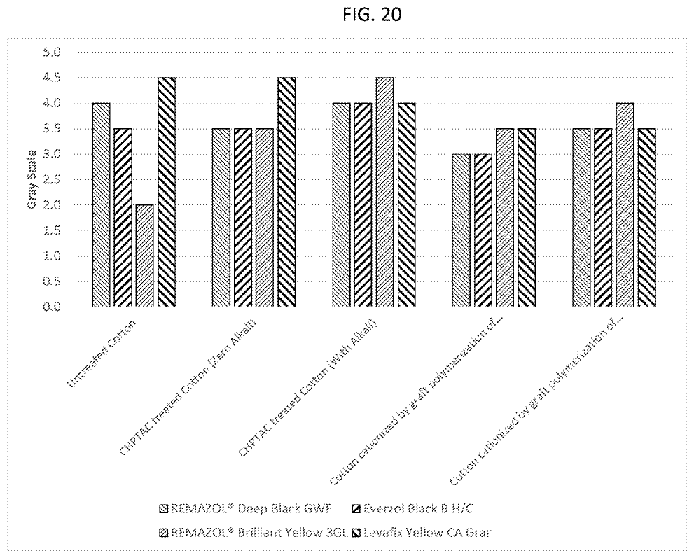

FIG. 20 shows the color change results for lightfastness of dyed untreated cotton, dyed CHPTAC-treated cotton, and dyed cotton cationized by graft polymerization of DADMAC in grayscale which were exposed to MIAMI conditions for 40 hours. As shown in FIG. 20, after 40 hours exposure to MIAMI conditions, the colorfastness to light of cotton cationized by graft polymerization of DADMAC dyed with Na₂CO₃ was comparable to CHPTAC-treated cotton dyed with Na₂CO₃ for REMAZOL® Deep Black GWF, Everzol Black B H/C, REMAZOL® Brilliant Yellow 3GL and Levafix Yellow CA Gran. Again, after 40 hours exposure to MIAMI conditions, colorfastness to light of cotton cationized by graft polymerization of DADMAC dyed with Na₂CO₃ was comparable to untreated cotton dyed with Na₂SO₄ and Na₂CO₃ for REMAZOL® Deep Black GWF and Everzol Black B H/C. On the other hand, after 40 hours exposure to MIAMI conditions, colorfastness to light of cotton cationized by graft polymerization of DADMAC dyed with Na₂CO₃ was higher than untreated cotton dyed with Na₂SO₄ and Na₂CO₃ for REMAZOL® Deep Black GWF, but lower for Levafix Yellow CA Gran. Again, after 40 hours exposure to MIAMI conditions, the colorfastness to light of cotton cationized by graft polymerization of DADMAC dyed with zero Na₂CO₃ was comparable to CHPTAC-treated cotton dyed with zero Na₂CO₃ for REMAZOL® Deep Black GWF, Everzol Black B H/C and REMAZOL® Brilliant Yellow 3GL, but lower for Levafix Yellow CA Gran.

### Example 5. Pad-Steam-Dry Dyeing with Acid and Direct Dyes

In the Pad-Steam-Dry method, CHPTAC-treated cotton (reference) and cotton cationized by graft polymerization of DADMAC (inventive; prepared according to Example 1) were dyed with an acid dye (Erionyl Yellow A-3G) and with a direct dye (Permalite Yellow 2RLSW NEW). Cationized cotton fabrics were also cut into rectangular pieces (Size≈0.43 m×0.43 m, Weight≈32 g) and padded with dye solutions containing 120 g/L of dye and 4% Leveler XCP 2. To ensure uniform ultra-deep dyeing, cotton fabrics were padded at 1.5 bar and 1 m/min using HVF padding machine to obtain about 70% wet pick up. Padded cotton fabrics were steamed for 1.5 min using a DHE oven (Werner Mathis AG) and dried at 160° C. for 2 min using a LTF oven (Werner Mathis AG) to complete the dyeing process.

Dyed fabrics were rinsed in cold water followed by washing in a bath containing 0.5 g/L of nonionic detergent (Apollo Scour) in boiling water for 5 min. Washed cotton fabrics were centrifuged to extract the excess water and dried in an oven.

### Color Yield

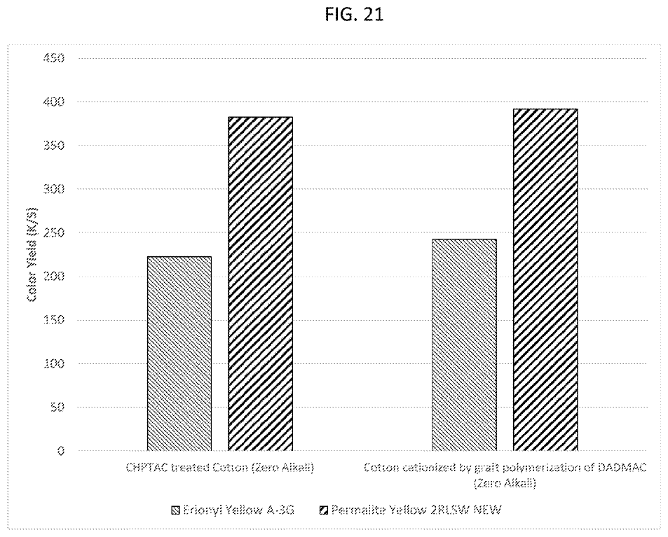

FIG. 21 shows the color yield of CHPTAC-treated cotton and cotton cationized by graft polymerization of DADMAC when dyed with Erionyl Yellow A-3G and Permalite Yellow 2RLSW NEW using the Pad-Steam-Dry method. As shown in FIG. 21, the color yield of cotton cationized by graft polymerization of DADMAC was higher than CHPTAC-treated cotton when dyed with Erionyl Yellow A-3G and Permalite Yellow 2RLSW NEW.

### Colorfastness Properties

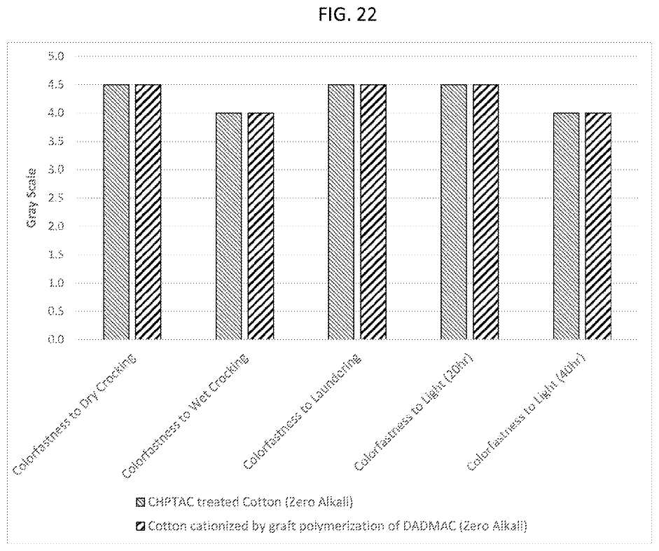

FIG. 22 shows the colorfastness results of CHPTAC-treated cotton and cotton cationized by graft polymerization of DADMAC in grayscale when dyed with Erionyl Yellow A-3G. As shown in FIG. 22, colorfastness to crocking, laundering and light of cotton cationized by graft polymerization of DADMAC was the same as CHPTAC-treated cotton when dyed with Erionyl Yellow A-3G.

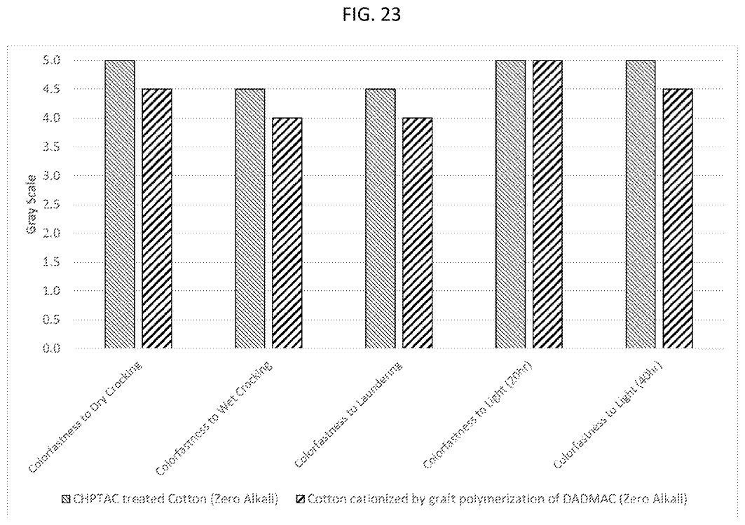

FIG. 23 shows the colorfastness results of CHPTAC-treated cotton and cotton cationized by graft polymerization of DADMAC in grayscale when dyed with Permalite Yellow 2RLSW NEW. As shown in FIG. 23, colorfastness to crocking, laundering and light of cotton cationized by graft polymerization of DADMAC was comparable to CHPTAC-treated cotton when dyed with Permalite Yellow 2RLSW NEW.

### Example 6. Foam Dyeing with Reactive and Direct Dyes

Table 1 shows the list of dyes and foam dyeing conditions for dyeing cotton cationized by graft polymerization of DADMAC (inventive; prepared according to Example 1).

TABLE 1
List of dyes and foam dyeing conditions used.

| | | Dye | Wet | Steam | Drying |
|---|---|---|---|---|---|
| | | Conc. | Pickup | Time | Time |
| Color | Dyes | (g/L) | (%) | (min) | (min) |
| Black | Qualactive Deep | 120 | 70 | 1.5 | 2 |
| (Q) | Black DD-GB | | | | |
| Black | Everzol Black | 150 | 50 | 1.5 | 2 |
| (E) | ED-R | | | | |
| Gold | Reactive Blue SL | 80 | 30 | 1.5 | 2 |
| | (0.19 g/L), Chromazol | | | | |
| | Yellow E-3A 180% | | | | |
| | PD (11.7 g/L) and | | | | |
| | Chromazol Red E-5B | | | | |
| | 120% PD (0.58 g/L) | | | | |
| Cyan | Qualfast Yellow ARL | 80 | 30 | 1.5 | 2 |
| | 200 (0.524 g/L), | | | | |
| | Direct fast Red | | | | |
| | 2HT (0.17 g/L) and | | | | |
| | Direct fast Blue | | | | |
| | FGL (7.33 g/L) | | | | |

### Color Yield and Colorfastness Properties:

Table 2 shows the color yield and colorfastness results of cotton cationized by graft polymerization of DADMAC dyed to black, gold and cyan colors.

TABLE 2
Color yield and colorfastness results of cotton cationized by graft
polymerization of DADMAC dyed to back, gold and cyan colors.

| Properties | Black (Q) | Black (E) | Gold | Cyan |
|---|---|---|---|---|
| Color Yield (K/S) Total | 898.77 | 937.34 | 32.02 | 54.09 |
| Colorfastness to dry crocking | 4.0 | 4.5 | 5.0 | 4.5 |
| Colorfastness to wet crocking | 2.0 | 3.0 | 4.5 | 4.0 |
| Colorfastness to Laundering | 3.5 | 4.0 | 5.0 | 5.0 |
| Color Yield after Laundering Test | 708.37 | 777.43 | 36.49 | 54.46 |
| 2A Wash Test | 4.0 | 4.0 | 5.0 | 5.0 |
| Colorfastness to Light (20 hours) | 5.0 | 5.0 | 4.0 | 5.0 |
| Colorfastness to Light (40 hours) | 4.5 | 4.5 | 3.0 | 4.5 |

As shown in Table 2, the color yield and colorfastness properties of cotton cationized by graft polymerization of DADMAC dyed to gold and cyan colors, using foam dyeing using zero salt and zero alkali, were very good to excellent. In the case of darker shades, the colorfastness to laundering and wet crocking was very good to acceptable, respectively, even when high concentration (150 g/L) of Black (E) was used.

### Example 7. Antimicrobial Properties

For antimicrobial tests, cotton cationized by graft polymerization of DADMAC (inventive; prepared according to Example 1) was dyed with or without alkali using Everzol Black B H/C, REMAZOL® Deep Black GWF and REMAZOL® Brilliant Yellow 3GL. These 6 samples were assigned the codes shown in Table 3 and were tested against Gram-positive and -negative bacteria.

TABLE 3
Coded Names of cotton cationized by graft polymerization of DADMAC
dyed with or without alkali using Everzol Black B H/C. Remazol ® Deep
Black GWF and Remazol ® Brilliant Yellow 3GL.

| Coded | |
|---|---|
| Name | Description |
| EBC-O | Cotton cationized by graft polymerization of |
| | DADMAC dyed with zero Na₂CO₃ using Everzol |
| | Black B H/C. |
| EBC-A | Cotton cationized by graft polymerization of |
| | DADMAC dyed with Na₂CO₃ using Everzol |
| | Black B H/C. |
| RDBG-O | Cotton cationized by graft polymerization of |
| | DADMAC dyed with zero Na₂CO₃ using REMAZOL ® |
| | Deep Black GWF. |
| RDBG-A | Cotton cationized by graft polymerization of |
| | DADMAC dyed with Na₂CO₃ using REMAZOL ® |
| | Deep Black GWF. |
| RBY-O | Cotton cationized by graft polymerization of |
| | DADMAC dyed with zero Na₂CO₃ using REMAZOL ® |
| | Brilliant Yellow 3GL. |
| RBY-A | Cotton cationized by graft polymerization of |
| | DADMAC dyed with Na₂CO₃ using REMAZOL ® |
| | Brilliant Yellow 3GL. |

Tables 4 and 5, below, provide details regarding antimicrobial testing method details (Table 4) and results (Table 5) against Gram Positive bacteria: Staphylococcus aureus.

TABLE 4
Test Method Details.

| Test Method | AATCC TM 100-2019 | |
|---|---|---|
| Test Organism | Staphylococcus aureus (ATCC #6538) | |
| Test Solution | Tryptic Soy Broth (TSB) in deionized | |
| Nutrient Load | H₂O (1:20) with Triton | |
| | X-100 (0.05%) surfactant | |
| Test Sample | 4.8 cm diameter | |
| Dimensions | circular swatches | |
| Inoculum Applied | 1.0 | mL |
| to Test Sample | | |
| Contact Time | 24 | hours |

| | |
|---|---|
| Neutralizer | 100 mL Dey/Engley (D/E) |
| | Neutralizing Broth (1x) |
| Measuring Method | Dilution Plate Method on |
| of Number of | Tryptic Soy Agar (TSA) |
| Living Bacteria | |
| Method of | none |
| Sterilization/ | |
| Laundering | |

TABLE 5
Results with Gram positive bacteria.
AATCC TM 100 Antibacterial Finishes on Textile Materials

| Number of Replicate Experiments | | 2 | | |
|---|---|---|---|---|
| Average Concentration of | | 5.48E+04 = 4.74 log | | |
| Inoculum (CFU/mL) | | | | |
| Average Control after 24 hours | | 3.64E+08 = 8.56 log | | |
| incubation (CFU/sample) | | | | |
| Average Control Growth Value | | 3.94 log | | |
| | Average | | Average | |
| | Bacteria | Average | Log | Average % |
| | Recovered | Log | Reduction | Reduction |
| | (CFU/sample) | Recovery | (vs. Control | (vs. Control |
| Sample name | at 24 hours | at 24 hours | at 24 hours) | at 24 hours) |
| EBC-O Sample | 0.00E+00 | 0.00 | 8.56 | 100.00% |
| EBC-A Sample | 0.00E+00 | 0.00 | 8.56 | 100.00% |
| RDBG-O Sample | 0.00E+00 | 0.00 | 8.56 | 100.00% |
| RDBG-A Sample | 0.00E+00 | 0.00 | 8.56 | 100.00% |
| RBY-O Sample | 1.00E+03 | 3.00 | 5.56 | >99.99% |
| RBY-A Sample | 7.83E+03 | 3.89 | 4.67 | >99.99% |

As shown in Table 5, the results against gram positive bacteria showed that all 6 samples exhibited high efficacy of more than 99.99% reduction in bacteria colonies compared to the control after 24 hours.

The same dyed samples were tested against gram negative bacteria (K. pneumoniae) using AATCC TM100, and all the samples exhibited more than 99.9% reduction in bacteria colonies except two samples, one showing 99.31% reduction and the second sample showing 89.08% reduction. See Tables 6 and 7, below. Compared to gram positive bacteria, gram negative bacteria are known to be more resistant towards antimicrobials due to the unique structure of the outer membrane of gram-negative bacteria, which makes it difficult for antimicrobials to penetrate and puncture through the cell wall.

TABLE 6
Test Method Details.

| Test Method | AATCC TM 100-2019 | |
|---|---|---|
| Test Organism | Klebsiella pneumoniae (ATCC #4352) | |
| Test Solution Nutrient Load | Tryptic Soy Broth (TSB) in deionized | |
| | H₂O (1:20) with Triton | |
| | X-100 (0.05%) surfactant | |
| Test Sample Dimensions | 4.8 cm diameter | |
| | circular swatches | |
| Inoculum Applied to | 1.0 | mL |
| Test Sample | | |
| Contact Time | 24 | hours |

| | |
|---|---|
| Neutralizer | 100 mL Dey/Engley (D/E) |
| | Neutralizing Broth (1x) |
| Measuring Method of Number | Dilution Plate Method on |
| of Living Bacteria | Tryptic Soy Agar (TSA) |
| Method of Sterilization/ | none |
| Laundering | |

TABLE 7
Results with Gram negative bacteria.
AATCC TM 100 Antibacterial Finishes on Textile Materials

| Number of Replicate Experiments | | 2 | | |
|---|---|---|---|---|
| Average Concentration of | | 9.13E+04 = 4.96 log | | |
| Inoculum (CFU/mL) | | | | |
| Average Control after 24 hours | | 4.80E+08 = 8.68 log | | |
| incubation (CFU/sample) | | | | |
| Average Control Growth Value | | 3.99 log | | |
| | Average | | Average | |
| | Bacteria | Average | Log | Average % |
| | Recovered | Log | Reduction | Reduction |
| | (CFU/sample) | Recovery | (vs. Control | (vs. Control |
| Sample name | at 24 hours | at 24 hours | at 24 hours) | at 24 hours) |
| EBC-O Sample | 3.31E+06 | 6.52 | 2.16 | 99.31% |
| EBC-A Sample | 2.95E+05 | 5.47 | 3.21 | 99.94% |
| RDBG-O Sample | 4.00E+02 | 2.60 | 6.08 | >99.99% |
| RDBG-A Sample | 5.40E+03 | 3.73 | 4.95 | >99.99% |
| RBY-O Sample | 5.25E+07 | 7.72 | 0.96 | 89.08% |
| RBY-A Sample | 3.40E+03 | 3.53 | 5.15 | >99.99% |

### Example 8. Determination of Molecular Weight of Poly-DADMAC Cationized Cotton

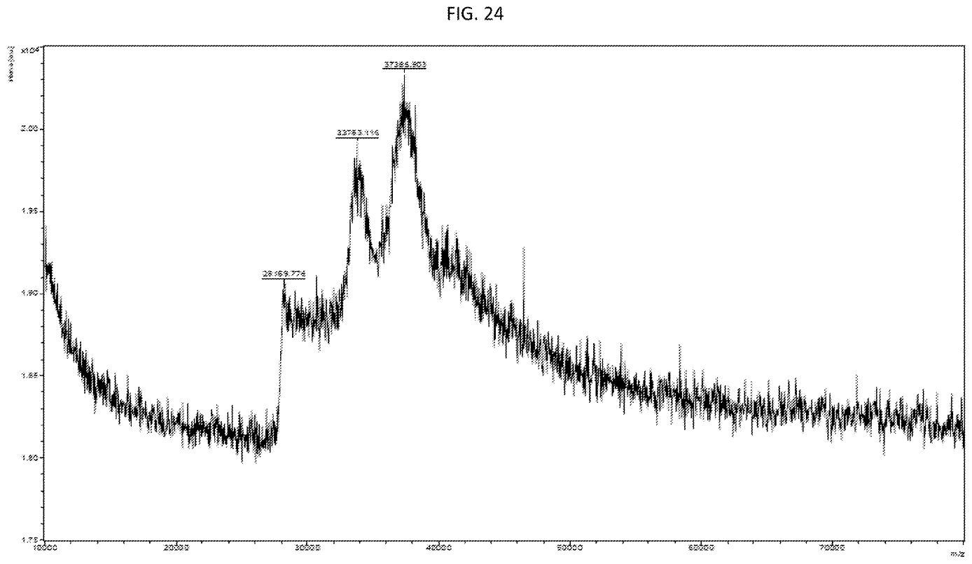

The cationized cotton of Example 1 was analyzed to determine the molecular weight of the poly-DADMAC polymer chain resulting from the graft polymerization. Specifically, poly-DADMAC polymer was extracted from the graft polymerized cotton by treatment with the cellulase enzyme obtained from Aspergillus sp. The sample of extracted poly-DADMAC was subjected to MALDI TOF-MS (Bruker Autoflex Max). The matrix used for the analysis was sinapinic acid in acetonitrile:water:trifluoroacetic acid (50:50:0.1). The molecular weight of the poly-DADMAC was in the range of 28,000-40,000 daltons (FIG. 24). It is noted that this molecular weight range is merely exemplary, and lower and higher molecular weights of poly-DADMAC can be achieved depending on e.g., the molar ratio of initiator, monomer, and crosslinker, as well as the curing time.

### Example 9. Graft Polymerization of Poly-DADMAC into Cotton Twill

Cotton twill of 258 gsm (Size=0.43 m×0.43 m, weight≈32 g) was padded (1 dip & 1 nip) with a solution containing 84 wt. % Poly-DADMAC solution (average MW of 200,000-350,000; 20 wt % in H₂O) at 1 bar and 1 m/min using HVF padding machine (Werner Mathis AG) to obtain about 90% wet pick up. Alternatively, 2 dip & 2 nip or 3 dip & 3 nip can be used depending on the need and nature of the fabrics. Wet cotton fabrics were dried at 80-130° C. for 3 min using LTF oven (Werner Mathis AG). Dried cotton fabrics were padded again with a solution containing 3% owb potassium persulfate at 1 bar and 1 m/min using HVF padding machine. Wet cotton fabrics were dried at 80-130° C. for 3 min and cured at 110-180° C. for 1.5 min using an LTF oven. Cured cotton fabrics were washed for 5 min with water at 65° C. to remove ungrafted poly-DADMAC from cotton fabrics. Washed cotton fabrics were centrifuged and dried to obtain 9% dry add-on.

### Example 10. Graft Polymerization of Poly-DADMAC into Cotton Twill

The procedure of Example 9 was followed to cationize cotton but using a poly-DADMAC solution with an average MW of less than 100,000 (35 wt % in H₂O) to provide a cationized cotton twill comprising a higher molecular weight poly-DADMAC polymer. The washed cotton fabrics were centrifuged and dried to obtain 7% dry add-on.

### Example 11. Graft Polymerization of Poly-DADMAC into Cotton Twill

The procedure of Example 9 was followed to cationize cotton but using a poly-DADMAC solution with an average MW of 400,000-500,000 (20 wt % in H₂O) to provide a cationized cotton twill comprising a higher molecular weight poly-DADMAC polymer.

### Example 12. Graft Polymerization of DADMAC into Cotton Twill

Cotton twill (Size=53.34 m×0.43 m, Weight≈5.6 kg) was padded (1 dip & 1 nip) with a solution containing 5-15 wt. % DADMAC solution, 1-3% owb potassium persulfate, 1.2-2% owb pentaerythritol tetraacrylate, and 2.4% owb nonionic surfactant. Cotton fabrics were padded at 1 bar and 0.5 m/min using HVF padding machine (Werner Mathis AG) to obtain about 80% wet pick up. Wet cotton fabrics were dried continuously at 80-130° C. for 3 min and cured at 110-180° C. for 1.5 min using THN tenter frame oven (Werner Mathis AG). Cured cotton fabrics were washed 3 times with water at 65° C. using a Jet machine (Thies GmbH & Co.) to remove ungrafted poly-DADMAC from cotton fabrics. Washed cotton fabrics were padded using HVF padding machine at 6 bar and 4 m/min to extract excess water and dried at 120° C. for 1 min using THN tenter frame oven at air speed of 86 m/sec and fabric tension 6 to obtain 2-6% dry add-on.

### Example 13. Determination of Nitrogen Content by Elemental Analysis

Samples of the cationized cotton twill of Examples 9, 10, 11, and 12 were analyzed to determine the average wt % of nitrogen present across the various molecular weight ranges of the poly-DADMAC polymer chains. The results are provided in Table 8, which demonstrates that cotton graft polymerized with DADMAC had the highest weight percent of N. The percent of N in cotton grafted with poly-DADMAC (MW=200,000-350,000) was comparable to cotton grafted with poly-DADMAC (MW=400,000-500,000), but cotton grafted with poly-DADMAC (MW<100,000) had the lowest % N.

TABLE 8
Average wt. % of N in cotton grafted with Poly-
DADMAC and cotton graft polymerized with DADMAC

| | Average wt. |
|---|---|
| Example # (Treatment) | % of N |
| Example 9 (Cotton grafted with poly- | 0.19 |
| DADMAC (MW = 200,000-350,000)) | |
| Example 10 (Cotton grafted with poly- | 0.065 |
| DADMAC (MW < 100,000)) | |
| Example 11 (Cotton grafted with poly- | 0.185 |
| DADMAC (MW = 400,000-500,000)) | |
| Example 12 (Cotton graft polymerized | 0.25 |
| with DADMAC) | |

### Example 14. Analysis of DADMAC-Grafted Cotton by x-Ray Photoelectron Spectroscopy (XPS)

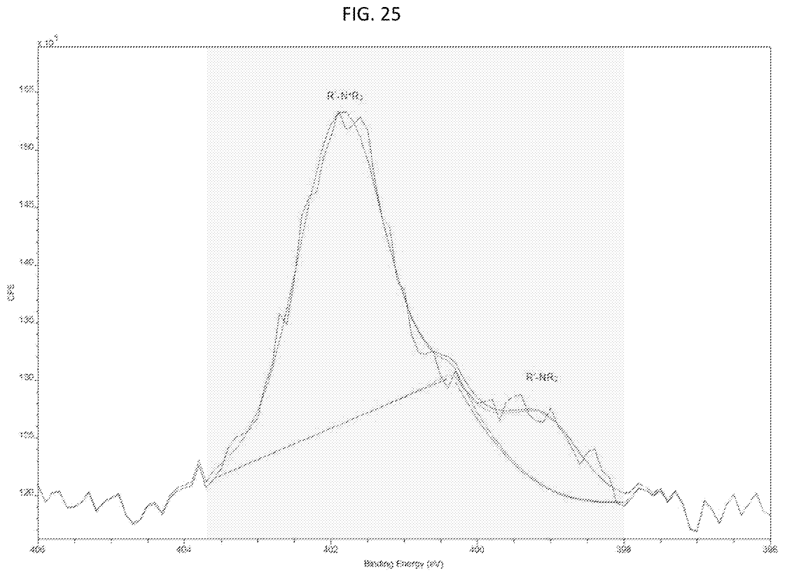

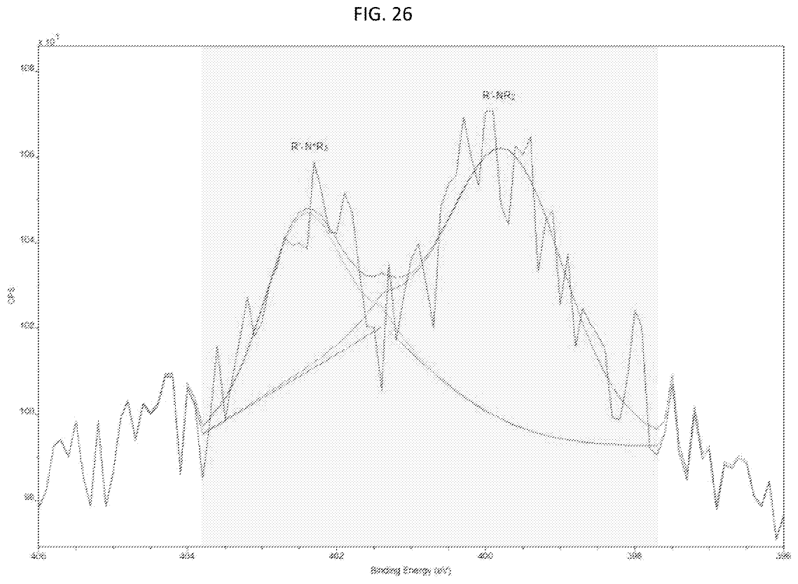

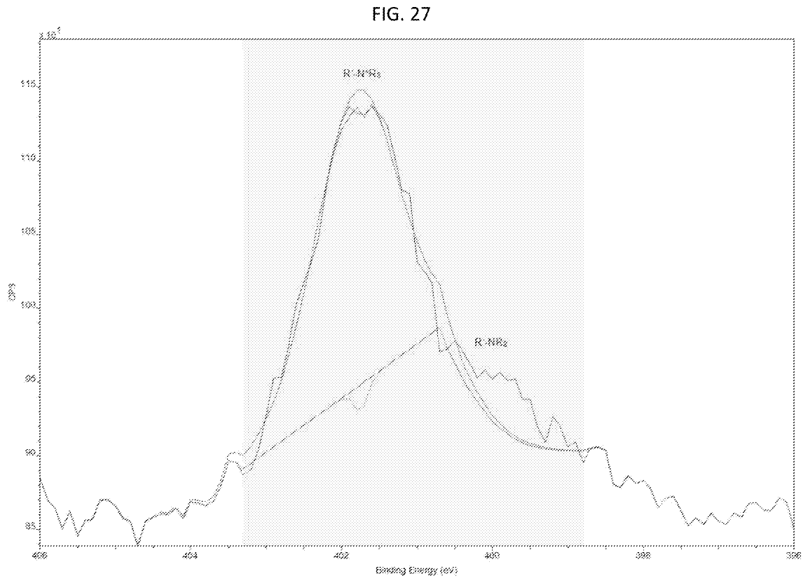

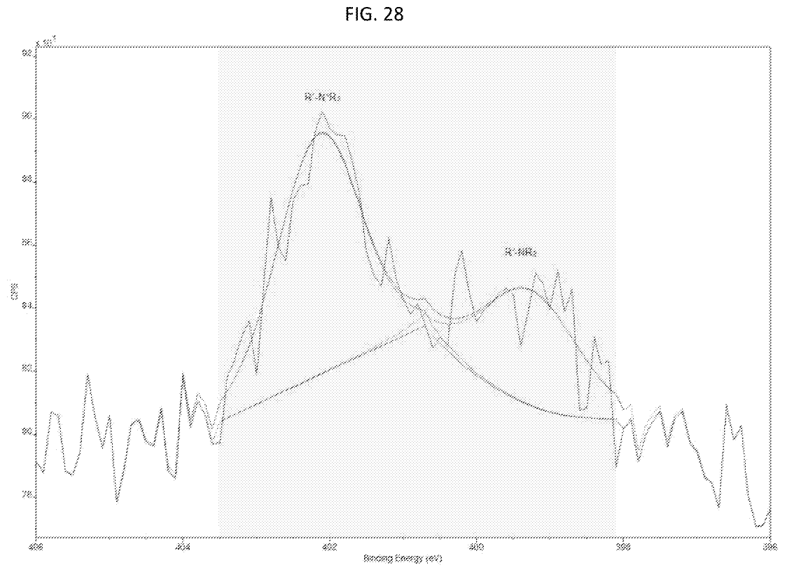

XPS spectra of samples of cotton from Examples 9 to 12 were obtained. For discussion of determination of amino groups via XPS, see Ederer et al., “Determination of amino groups on functionalized graphene oxide for polyurethane nanomaterials: XPS quantitation vs. functional speciation” RSC Advances, 2017, 7(21), pp 12464-12473. The spectra for the cationized cottons are provided as FIGS. 25 to 28, respectively. With reference to FIG. 25, the peak at due 401.9 eV to the ionization of inner N (quaternary ammonium) is significantly greater than that of the peak corresponding to the outer, uncharged nitrogen at 399 eV for the product of Example 9. With reference to FIG. 26, the intensity of the peak corresponding to quaternary nitrogen at 402.3 eV is less than that of the peak at 399.9 eV, confirming less quaternary ammonium nitrogen relative to uncharged nitrogen for the product of Example 10. With reference to FIG. 27, the peak intensity at 401.8 eV was also much greater than that of the peak at 399.7 eV, which confirms that the percent quaternary ammonium nitrogen is significantly higher than that of uncharged nitrogen for the product of Example 11. With reference to FIG. 28, the peak at 402.1 eV is significantly higher than that of uncharged nitrogen for the product of Example 12. The presence of a higher relative amount of quaternary nitrogen bonded to the fabric as compared to non-quaternary ammonium nitrogen indicates that more cationic polymer has been incorporated than other nitrogen-containing polymer, such as that arising from certain crosslinkers.

### Example 15. Dyeing of Cotton Grafted with DADMAC and Poly-DADMAC

Cottons grafted with Poly-DADMAC (Examples 9, 10, and 11) and cotton graft polymerized with DADMAC (Example 12) were dyed using both the exhaustion method and pad-steam-dry method. In the exhaustion method, the cationized cotton fabrics were dyed with 4% owf Remazol® Deep Black GWF at 10:1 liquor ratio in a Datacolor AHIBA NUANCE, model 1000 (Salvis AG, Switzerland). Cationized cotton fabrics (size approximately 0.36 m×0.17 m, weight approximately 17 g) were dyed with or without Na₂CO₃. Cationized cotton fabrics were put in a beaker containing water and 0.5% owb Pomolev NHM at room temperature (RT). Lid of the beaker was sealed; the temperature of the machine was raised to 30° C. and the beaker was revolved for 10 min. Dye solution was added to the beaker incrementally and the beaker was revolved for another 10 min at 30° C. Then the temperature of the machine was raised at 2.5° C. per min to 60° C. Dyeing was completed after 40 min when no Na₂CO₃ was used. On the other hand, when the cationized cotton fabrics were dyed with Na₂CO₃, 18 g/L of Na₂CO₃ was added in increments, the temperature was raised to 60° C. and held for 40 min. Dyed fabrics were rinsed in cold water followed by washing in a bath containing 0.5 g/L of nonionic detergent (Apollo Scour) in boiling water for 5 min. Washed cotton fabrics were centrifuged to extract the excess water and dried in an oven.

### Example 16. Comparative Study of Color Yields

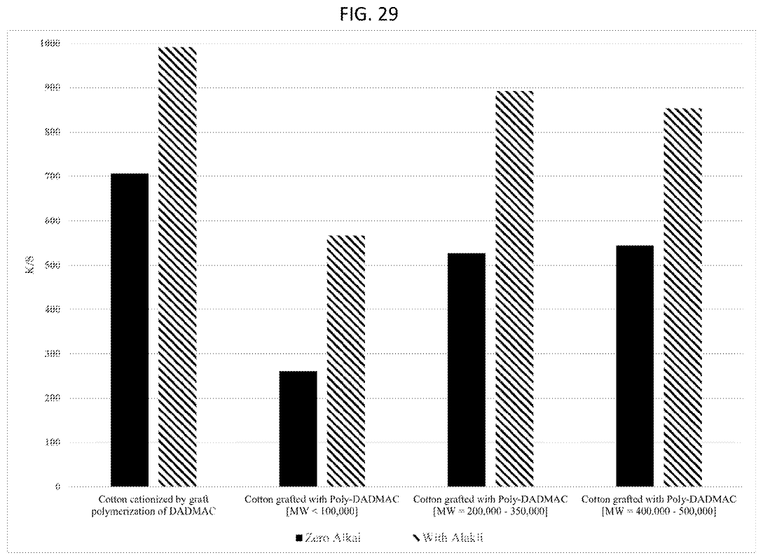

The dyed cotton materials of Example 15 were analyzed for color yield. The color yields, expressed as absorption coefficient/scattering coefficient (K/S) ratios, are provided in FIG. 29. With reference to FIG. 29, the color yield of dyed cotton graft polymerized with DADMAC (Example 12) was the highest compared to dyed cotton grafted with different molecular weights of poly-DADMAC. It was also clear that the color yield of poly-DADMAC of 200,000-350,000 was comparable to 400,000-500,000, while the color yield of dyed cotton grafted with poly-DADMAC (MW<100,000) was the lowest. The color yield of dyed cotton graft polymerized with DADMAC was the highest due to the presence of more quaternary nitrogen (N*), resulting in more dye uptake and, hence, a deeper shade.

### Example 17. Graft Polymerization of DADMAC into Cotton Knit Fabric

Cotton fabrics (Weight≈600 g) were padded (1 dip & 1 nip) with an aqueous solution containing 5 to 25 wt. % diallyldimethylammonium chloride (DADMAC) solution (65 wt. % in H₂O), 0.5-3.2% sodium persulfate on the basis of weight of bath (owb), and 1 to 2% owb N,N′-methylenebisacrylamide (MBA). Cotton fabrics were padded at 1 bar and 0.6 m/min to obtain about 86% wet pick up. Wet cotton fabrics were dried and cured at 110-180° C. using a Mathis THS 500 mm Tenter Frame for 1-4 minutes. Cured cotton fabrics were placed in a JFO Mathis Machine, then the machine was filled with water to the proper level, and the temperature was raised to 65° C. and held for 5-15 minutes. The hot wash was followed by cold wash, to remove any remaining homopolymer or ungrafted poly-DADMAC. The hot and cold washes are optional depending on the required fastness properties The washed cotton fabrics were centrifuged to extract excess water and dried in a dryer to obtain 2-11.2% dry add-on.

### Example 18. Exhaustion Dyeing of Cotton Knit Fabrics

Cotton cationized by graft polymerization of DADMAC (inventive; prepared according to Example 17) were dyed with 3.5% on weight of fiber (owf) Qualactive Deep Black RGB at a 10:1 liquor ratio in JFO Mathis Machine using the exhaustion method. Cationized cotton fabrics were placed in the JFO Mathis Machine, and the machine was filled with water to the proper level (10:1 liquor ratio), and the fabric was circulated for 5-10 minutes. Then, the temperature was raised to 60° C. at 2.5° C./min, the dye was added in five increments, and the temperature was held at 60° C. for 20 minutes, resulting in clear dye bath. The dye bath was drained, and the machine was filled with water to the proper level, 0.25 g/L Apollo (non-ionic scouring agent) was added, the temperature was raised to 95° C. and held for 15 minutes (optional depending on the level of fastness required). Then, the machine was filled with water to the proper level, circulated for 5 minutes and drained.

For a comparative reference, cotton fabrics which had not been cationized according to the disclosed method were cut into rectangular (weight≈6.6 g) and placed in a 300 mL stainless steel beaker containing water and 65 g/L of Na₂SO₄. The lid of the beaker was sealed and placed in Ahiba IR Pro dyeing machine; the temperature of the machine was raised to 30° C., and the fabric was revolved for 10 min. Then, 3.5% OWF of Qualactive Deep Black RGB solution was added to the beaker and revolved for an additional 10 min at 30° C. Then, the temperature of the machine was raised at 0.5-2.5° C./min to 60° C. and the dyeing was continued for 40 min. After 40 min, 18 g/L of sodium carbonate was added to the bath, and dyeing was continued for another 40 min. The resulting dyed fabrics were rinsed in cold water before being washed for 5 minutes in a bath containing 0.5 g/L of non-ionic detergent (Apollo Scour) in boiling water and dried in a DKN810 oven.

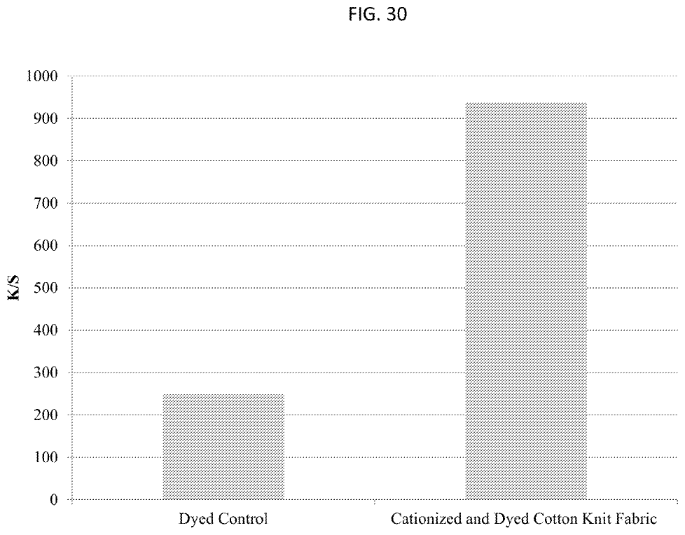

The color yields of the dyed inventive and reference fabrics were determined and compared (FIG. 30). With reference to FIG. 30, the color yield of the cationized cotton knit, dyed using no salts (no Na₂SO₄ and no Na₂CO₃) was almost four times higher than the reference (uncationized) cotton knit, dyed using both Na₂SO₄ and Na₂CO₃.

### REFERENCES

All references listed herein including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
1. Bashar, M. M. and Khan, M. A. (2013). An Overview on Surface Modification of Cotton Fiber for Apparel Use. Journal of polymers and the environment, 21(1), pp 181-190.
2. Fu, S., Hinks, D., Hauser, P. and Ankeny, M. (2013). High efficiency ultra-deep dyeing of cotton via mercerization and cationization. Cellulose, 20(6), pp 3101-3110.
3. Acharya, S., Abidi, N., Rajbhandari, R. and Meulewaeter, F. (2014). Chemical cationization of cotton fabric for improved dye uptake. Cellulose, 21(6), pp 4693-4706.
4. Wang, L., Ma, W., Zhang, S. and Teng, X., and Yang, J. (2009). Preparation of cationic cotton with two-bath pad-bake process and its application in salt-free dyeing. Carbohydrate Polymers, 78(3), pp 602-608.
5. Arivithamani, N. and Giri Dev, V. R. (2017). Cationization of cotton for industrial scale salt-free reactive dyeing of garments. Clean technologies and environmental policy, 19(9), pp 2317-2326.
6. Hauser, P. J. (2000). Reducing Pollution and Energy Requirements in Cotton Dyeing. Textile Chemist and Colorist & American Dyestuff Reporter, 32(6), pp 44-48.
7. Khatri, A., Padhey. R. and White, M. (2013). The use of trisodium nitrilo triacetate in the pad-steam dyeing of cotton with reactive dyes. Coloration Technology, 129(1), pp 76-81.
8. Hauser, P. J. and Tabba, A. H. (2001). Improving the environmental and economic aspects of cotton dyeing using a cationised cotton. Coloration Technology, 117(5), pp 282-288.
9. Montazer, M., Malek, R. M. A. and Rahimi, A. (2007). Salt free reactive dyeing of cationized cotton. Fibers and Polymers, 8(6), pp 608-612.
10. Khatri, A., Padhey. R., White, M. and Cowlishaw, K. (2010). Biodegradable organic salts for reactive dyeing of cotton. Fashion: Sustainability and Creativity 2010 IFFTI Conference, pp 378-382.
11. Khatri, A. (2011). Use of Biodegradable Organic Salts for Pad-Steam Dyeing of Cotton Textiles With Reactive Dyes to Improve Process Sustainability. 2011 International conference on education research and innovation, Vol. 8, pp 84-89.
12. Varadarajan, G. and Venkatachalam, P. (2016). Sustainable textile dyeing processes. Environmental chemistry letters, 14(1), pp 113-122.
13. Hauser, P. J. and Tabba, A. H. (2001). Improving the environmental and economic aspects of cotton dyeing using a cationised cotton. Coloration Technology, 117(5), pp 282-288.
14. Hauser, P. J. and Tabba, A. H. (2002). Dyeing cationic cotton with fiber reactive dyes: Effect of reactive chemistries. AATCC Review, 2(5), pp 36-39.
15. Lewis D. M. and Vo, L. T. T. (2007). Dyeing cotton with reactive dyes under neutral conditions. Coloration technology, 123(5), pp 306-311.
16. Aktek, T. and Millat, A. K. M. M. (2017). Salt Free Dyeing of Cotton Fiber—A Critical Review. International Journal of Textile Science, 6(2), pp 21-33.
17. Arivithamani, N. and Giri Dev, V. R. (2019). Characterization and comparison ofsalt-free reactive dyed cationized cotton hosiery fabrics with that of conventional dyed cotton fabrics. Journal of Cleaner Production, Vol. 183, pp 579-589.
18. Teng, X., Zhang, S. and Ma, W. (2011). Application of A Hydrolyzable Cationic Agent, Poly(acryloxyethyl trimethylammonium chloride), in Salt-Free Reactive Dyeing for Good Dyeing Properties. Journal of applied polymer science, 122(4), pp 2741-2748.
19. Niu, T., Wang, X., Wu, C., Sun, D., Zhang, X., Chen, Z. and Fang, L. (2020). Chemical Modification of Cotton Fabrics by a Bifunctional Cationic Polymer for Salt-Free Reactive Dyeing. ACS omega, 5(25), pp 15409-15416.
20. Hashem, M. M. (2006). Development of a one-stage process for pretreatment and cationisation of cotton fabric. Coloration Technology, 122(3), pp 135-144.
21. Lewis, D. M. and Lei, X. (1991). New methods for improving the dyeability of cellulose fibers with reactive dyes. Journal of the Society of Dyers and Colourists, 107(3), pp 102-109.
22. Hauser, P. J. (2002). A cleaner way to color cotton. Environmental Health Perspectives, 110(5), pp 252-254.
23. Farrell, M. J. (2011). Sustainable cotton dyeing. Doctoral dissertation, North Carolina State University.
24. Mandal, S. (2013). Colorant Database for Cationized Cotton. Thesis, North Carolina State University.
25. Patino, A., Canal, C., Rodriguez, C., Caballero, G., Navarro, A. and Canal, J. M. (2011). Surface and bulk cotton fibre modifications: plasma and cationization. Influence on dyeing with reactive dye. Cellulose, 18(4), pp 1073-1083.
26. Farrell, M. J., Ormond, R. B. and Gabler, W. J. (2015). Quantitative analysis of trimethyl amine in cotton fabrics cationized with 3-chloro-2-hydroxypropyltrimethylammonium chloride. Cellulose, 22(5), pp 3435-3439.
27. European Union Risk Assessment. (2008). (3-chloro-2-hydroxypropyl)-trimethyl-ammonium chloride summary risk assessment. Accessed Oct. 25, 2019.
28. Wu, T. S. and Chen, K. M. (1993). New cationic agents for improving the dyeability of cellulose fibres. Part2-pretreating cotton with polyepichlorohydrin-amine polymers for improving dyeability with reactive dyes. Journal of the Society of Dyers and Colourists, 109(4), pp 153-158.
29. Blackburn, R. S. and Burkinshaw, S. M. (2003). Treatment of Cellulose with Cationic, Nucleophilic Polymers to Enable Reactive Dyeing at Neutral pH Without Electrolyte Addition. Journal of applied polymer science, 89(4), pp 1026-1031.
30. Ma, W. Zhang, S., Tang, B. and Yang, J. (2005). Pretreatment of cotton with poly(vinylamine chloride) for salt-free dyeing with reactive dyes. Coloration technology, 121(4), pp 193-197.
31. Dehabadi, V. A., Buschmann, H. and Gutmann, J. S. (2013). Pretreatment of cotton fabrics with polyamino carboxylic acids for salt-free dyeing of cotton with reactive dyes. Coloration technology, 129(2), pp 155-158.
32. Zhang, F., Chen, Y., Lin, H. and Lu, Y. (2007). Synthesis of an amino-terminated hyperbranched polymer and its application in reactive dyeing on cotton as a salt-free dyeing auxiliary. Coloration technology, 123(6), pp 351-357.
33. Zhang, F., Chen, Y., Lin, H., Wang, H. and Zhao, B. (2008). HBP-NH₂ grafted cottonfiber Preparation and salt-free dyeing properties. Carbohydrate polymers, 74(2), pp 250-256.
34. Zhang, F., Chen, Y. Y., Lin, H. and Zhang, D. S. (2008). Performance of Cotton Fabric Treated with an Amino-terminated Hyperbranched Polymer. Fibers and polymers, 9(5), pp 515-520.
35. Burkinshaw, S. M., Mignanelli, M., Froehling, P. E. and Bide, M. J. (2000). The use of dendrimers to modify the dyeing behaviour of reactive dyes on cotton. Dyes and pigments, 47(3), pp 259-267.
36. Lim, S. and Hudson, S. M. (2004). Application of a fibre-reactive chitosan derivative to cotton fabric as a zero-salt dyeing auxiliary. Coloration technology, 120(3), pp 108-113.
37. Sadeghi-Kiakhani, M. and Safapour, S. (2015). Salt-free reactive dyeing of the cotton fabric modified with chitosan-poly(propylene imine) dendrimer hybrid. Fibers and polymers, 16(5), pp 1075-1081.
38. Ali, S., Mughal, M. A., Shoukat, U., Baloch, M. A. and Kim, S. H. (2015). Cationic Starch (Q-TAC) Pre-Treatment of Cotton Fabric Influence on dyeing with reactive dye. Carbohydrate polymers, Vol. 117, pp 271-278.
39. Helmy, H. M., Hauser, P. J. and El-Shafei, A. (2017). Influence of atmospheric plasma-induced graft polymerization of DADMAC into cotton on dyeing with acid dyes. The Journal of the Textile Institute, 108(11), pp 1871-1878.
40. Ramamoorthy, A., Helmy, H. M., Rajbhandari, R., Hauser, P. J. and El-Shafei, A. (2016). Plasma Induced Graft Polymerization of Cationic and Fluorocarbon Monomers into Cotton: Enhanced Dyeability and Photostability. Industrial & Engineering Chemistry Research, 55(31), pp 8501-8508.
41. DADMAC HPV Committee. (2004). Test Plan for Diallyldimethylammonium Chloride (DADMAC). Retrieved from www.heritagesystemsinc.com/Downloads/WhitePapers/DADMAC-Enviromnental-Fate.pdf. Accessed Oct. 25, 2019.

1. A method of cationizing a cellulosic fiber or fabric by graft polymerization, the cellulosic fiber or fabric comprising polysaccharide chains comprising a plurality of glucose residues having hydroxymethyl groups, the method comprising:
contacting the cellulosic fiber or fabric with a cationic alkenyl monomer, a thermal initiator, and a crosslinker to form an impregnated cellulosic fiber or fabric; and
curing the impregnated cellulosic fiber or fabric to form a cationized cellulosic fiber or fabric, wherein the cationized cellulosic fiber or fabric comprises cationic polymeric side chains covalently bonded to at least a portion of the hydroxymethyl groups present in the plurality of glucose residues.

2. The method of claim 1, wherein the cationic alkenyl monomer comprises one or more allyl groups.

3. The method of claim 1, wherein the cationic alkenyl monomer comprises an acrylate, methacrylate, acrylamide, or methacrylamide group.

4. The method of claim 1, wherein the cationic alkenyl monomer is selected from the group consisting of diallyldimethyl ammonium chloride (DADMAC), 2-(acryloyloxy)ethyl trimethylammonium chloride (AOETMAC), 2-(methacryloyloxy)ethyl trimethylammonium chloride (MOETMAC), (3-acrylamidopropyl)trimethylammonium chloride (AAPTMAC), [3-(methylacryloylaminopropyl]trimethylammonium chloride (MAPTMAC), tetraallyl ammonium bromide (TAAB), tetraallyl ammonium chloride (TAAC), N,N,N′,N′-tetraallyl trimethylene dipiperidine dibromide (TAMPB), N,N,N′,N′-tetraallyl trimethylene dipiperidine dichloride (TAMPC), and combinations thereof.

5. The method of claim 1, wherein the cationic alkenyl monomer is DADMAC.

6. The method of claim 1, wherein the thermal initiator is selected from the group consisting of sodium potassium persulfate, potassium persulfate, ammonium persulfate, ceric ammonium nitrate, azobisisobutyronitrile, 2,2′-Azobis[2-methylpropionamidine]dihydrochloride, 4,4′-Azobis[4-cyanovaleric]acid, 2,2′-Azobis[2-methyl-N-(2-hydroxyethyl)propionamide], 2,2′-Azobis[2-(2-imidazolin-2-yl)propane]dihydrochloride, 4,4′-Azobis(4-cyanovaleric acid), or 2,2′-Azobis[N-(2-carboxyethyl)-2-methylpropionamidine]-tetrahydrate, organic peroxides, organic hydroperoxides, and combinations thereof.

7. The method of claim 6, wherein the thermal initiator is sodium persulfate or potassium persulfate.

8. The method of claim 1, wherein the crosslinker is selected from the group consisting of N,N′-methylenebisacrylamide (MBA), pentaerythritol triacrylate, N-[Tris(3-acrylamidopropoxymethyl)methyl]-acrylamide, a polyethylene glycol diacrylate, tetra(ethylene glycol diacrylate), pentaerythritol tetraacrylate, and combinations thereof.

9. The method of claim 8, wherein the crosslinker is selected from the group consisting of MBA, pentaerythritol tetraacrylate, a polyethylene glycol diacrylate, and tetra(ethylene glycol) diacrylate.

10. The method of claim 1, wherein contacting comprises dipping the cellulosic fiber or fabric into one or more solutions comprising one or more of the cationic alkenyl monomer, the thermal initiator, and the crosslinker.

11. The method of claim 10, wherein the cationic alkenyl monomer, thermal initiator, and crosslinker are present together in a single solution contacted with the cellulosic fiber or fabric.

12. The method of claim 10, wherein contacting comprises passing the cellulosic fiber or fabric through the one or more solutions in a continuous manner.

13. The method of claim 10, further comprising mechanically removing a portion of the one or more solutions from the impregnated fibers or fabric.

14. The method of claim 10, wherein the contacting is repeated sequentially two or more times.

15. The method of claim 1, wherein contacting the cellulosic fiber or fabric with the cationic alkenyl monomer, thermal initiator, and crosslinker is conducted at a temperature in a range from about 10° C. to about 50° C., and/or for a time period in a range from a few seconds to about 5 minutes.

16. The method of claim 1, further comprising, prior to the curing, drying the impregnated cellulosic fiber or fabric.

17. The method of claim 16, wherein the drying is conducted for a time period from about 2 minutes to about 8 minutes.

18. The method of claim 16, wherein the drying is conducted at a temperature in a range from about 80° C. to about 130° C.

19. The method of claim 1, wherein curing comprises exposing the impregnated cellulosic fiber or fabric to a temperature in a range from about 110° C. to about 180° C., such as about 130° C. to about 180° C., optionally for a time period from about 1 minute to about 3 minutes.

20. The method of claim 1, further comprising washing the cationized cellulosic fiber or fabric.

21. The method of claim 1, wherein the cellulosic fiber or fabric is cotton, a cotton blend, rayon, viscose, linen, modal, lyocell, or a combination thereof.

22. The method of claim 1, wherein the cellulosic fiber or fabric is in the form of a thread, yarn, knit, nonwoven, woven, terry, or velvet.

23-67. (canceled)
